(19) United States
(12) Patent Application Publication
(10) Pub. No.: US 2026/0161219 A1
(43) Pub. Date: Jun. 11, 2026

(54) VIRTUAL REALITY HEADSET AND ELECTRONIC DEVICE

(71) Applicant: Arman TAJMIRRIAHI, Isfahan (IR)

(72) Inventor: Arman TAJMIRRIAHI, Isfahan (IR)

(21) Appl. No.: 19/537,581

(22) Filed: Feb. 12, 2026

Related U.S. Application Data
(63) Continuation-in-part of application No. PCT/IB2024/054846, filed on May 18, 2024.

(30) Foreign Application Priority Data
Aug. 12, 2023 (WO) PCT/IR2023/003433

(51) Int. Cl. G06F 3/01; G06F 1/16; G06F 3/0354; G06F 3/16; H04R 1/02; H04R 1/10

(52) U.S. Cl. CPC G06F 3/012; G06F 1/163; G06F 3/03545; H04R 1/028; H04R 1/1008; H04R 1/1075; G06F 3/013; G06F 3/167; H04R 2499/15

(57) ABSTRACT

A virtual reality headset includes a main housing with side handles. An electronic display frame and a counterbalancing protective visor are movably coupled to the housing. Motors move the display frame in front of a user's face and the visor behind the head simultaneously. Sliding speaker boxes on the handles house speakers and chargeable earphones. A sensor suite includes a gyroscope and accelerometer for stability. The headset operates in two modes: a wearable mode where the display deploys, and a tabletop mode where the motors automatically orient the display toward the user. A modular unit on the housing and a portable charging case are also included.

### TECHNICAL FIELD

The present invention relates generally to wearable computing and display systems. More particularly, the present invention relates to a multi-modal head-mounted device that functions as a virtual reality (VR) or augmented reality (AR) headset and a tabletop interactive display. The system incorporates motorized articulation, ergonomic stabilization, and a convertible audio system designed to align with principles of human cognitive processing and prolonged user comfort.

The disclosed device integrates advanced human-machine interface (HMI) components, including articulating display frames, counterbalancing mechanisms, motorized headband adjustment, and removable speaker pods with integrated earbud chargers, into a single wearable platform. This platform is specifically engineered to operate in two distinct modes: a wearable mode, where the device is donned on a user's head with the display deployable in front of the user's eyes, and a fixed tabletop mode, where the device is placed on a surface and its display automatically or manually articulates to track and face the user.

### BACKGROUND ART

The relentless advancement of digital immersion technologies, epitomized by contemporary virtual and augmented reality systems, has been guided by a paradigm of sensory substitution and occlusion. This paradigm operates on the foundational assumption that fidelity (the resolution of displays, the precision of head-tracking, the breadth of the soundstage) is the primary determinant of experiential quality and utility. Consequently, state-of-the-art head-mounted displays have evolved into marvels of miniaturized optics and responsive sensors, yet they remain architecturally rooted in a model that seeks to temporarily replace the user's perceptual field with a computationally generated one. This approach, while successful in creating compelling simulations, inadvertently engenders a profound physiological and cognitive disconnect that has been largely unaddressed in the literature of human-computer interaction. The human brain is not a passive receiver of sensory data but an active, predictive organ that constructs models of reality based on multi-modal integration; when presented with a high-bandwidth, artificially coherent audiovisual stream in the absence of corroborative somatic, olfactory, gustatory, and confirmatory haptic feedback, it enters a state of perceptual ambiguity.

This ambiguity triggers a deep-seated, evolutionary cognitive filtering mechanism. The brain possesses sophisticated heuristics for distinguishing between internally generated percepts, such as dreams or memories, and externally generated, real-time interactions with the environment. A primary differentiator is the presence of a congruent, multi-sensory feedback loop involving agency and physical consequence. When a user dons a conventional VR headset, their visual and auditory cortices are flooded with engineered stimuli, yet their proprioceptive, vestibular, and tactile systems report a starkly different reality (one of physical stasis and isolation). This sensory dissonance, despite being sub-threshold for conscious discomfort in many users, signals to higher cognitive systems that the dominant percept is “unconfirmed” or “disembodied.” Neurologically, such input is processed along pathways analogous to those engaged during vivid dreaming or intense cinematic immersion, characterized by high immediate salience but poor encoding into the hippocampal-dependent declarative memory systems.

The result is what the inventor terms the “Artificial Dream” effect: experiences that are engaging in the present moment but leave a faint and rapidly decaying engrammatic trace. This is not a failure of user attention but a fundamental mismatch between the technology's output and the brain's innate framework for knowledge acquisition and consolidation. Memory consolidation, particularly the transformation of ephemeral short-term impressions into stable long-term knowledge, relies heavily on the richness of associative cues and the perceived real-world relevance of an event. An experience the brain categorizes as a form of sophisticated observation, rather than participatory engagement, is tagged for different, less durable storage. This explains the common phenomenological report where an individual can recall with precise detail a minor real-world interaction from years past yet struggle to recount the narrative sequence of a complex film or immersive VR narrative consumed merely days earlier.

Extending this analysis from the cognitive to the cybernetic, one can examine the brain's operational logic through the lens of information processing loops, or “stabilization rings.” Unlike a classical Turing machine or binary CPU operating on discrete symbols, the brain functions through continuous, self-reinforcing loops of perception, prediction, and action. These loops are not merely computational but are embodied, formed and solidified through developmental interaction with the physical world. A fundamental stabilization ring, for instance, is the equation 2=1+1. This is not merely an arithmetic fact but a perceptual-motor truth learned through the manipulation of objects, forming an unbreakable cognitive primitive. The brain develops a vast, interlinked lattice of such rings through ontogeny, each ring tying a concept to a suite of sensory-motor experiences, the weight, texture, scent, and taste of an apple, forming a holistic “appleness” ring that allows for instantaneous recognition and valuation.

Modern interface technologies, however, provide input that is often unidimensional, targeting primarily the visual and auditory modalities. This input lacks the multi-sensory corroboration required to engage or form robust stabilization rings. The brain, when receiving such impoverished input, cannot integrate it into its existing lattice of embodied knowledge with the same strength. It is processed as a secondary, derivative signal. This is why passive consumption of digital media, no matter how gripping, seldom results in the same depth of learning or memory as a hands-on, multi-sensory experience. The technological interface fails to complete the cognitive loop, leaving the brain's integrative mechanisms underutilized and the information itself cognitively “tagged” as transient.

The deficiency becomes particularly acute when considering the brain's inherent “supercomputer” capabilities for pattern recognition, inference, and creativity. This organic supercomputer is optimized for processing real-time, multi-modal data streams from a body in action. Its primary inputs are not binary data packets but the continuous analog signals from eyes, ears, skin, muscles, and the vestibular system. Its most powerful processing occurs not during focused, isolated attention on a screen, but during states of relaxed awareness and even sleep, when these multi-modal experiences are sorted, connected, and integrated into existing knowledge frameworks, a process essential for creativity and insight. Current HMDs, by isolating the user and hijacking dominant sensory channels, inadvertently stifle this background integrative processing. They demand constant, directed attention to the artificial environment, effectively creating a state of “artificial sleep” for the body's other senses and “cognitive load” for the brain's integrative networks.

Furthermore, the ergonomic design of existing systems introduces significant physiological friction that exacerbates cognitive disconnect. The weight distribution of conventional headsets creates anterior focal points of pressure on the frontal bone and zygomatic arches, potentially impeding superficial blood flow and causing discomfort that continually signals the brain to the artificiality and intrusion of the device. The need for a tight, immobile fit to maintain display alignment and tracking accuracy directly conflicts with the body's natural micro-movements and thermoregulatory needs, creating a persistent, low-level somatic stressor that further anchors the user's awareness to the device as a foreign object, not a seamless extension of self.

The audio implementations in most systems compound these issues. Fixed, occluding ear cups or simple insert speakers provide spatial audio but simultaneously create auditory isolation, severing the user from a critical channel of environmental awareness and confirmation. This enforced auditory deprivation completes the sensory occlusion strategy but violently contradicts the brain's expectation of auditory-visual congruence with its surroundings, deepening the state of disembodiment. The lack of dynamic, user-controlled audio integration between the digital and physical realms forces a binary choice: full immersion or full disengagement.

The problem space, therefore, is multi-dimensional. On a cognitive level, existing technologies fail to align with the brain's multi-sensory, embodied framework for information valuation and memory encoding, leading to the “Artificial Dream” effect and inefficient knowledge retention. On a cybernetic level, they provide input insufficient to engage the brain's powerful stabilization ring architecture, resulting in weak cognitive integration. On a physiological level, their ergonomic and sensory-isolating designs create discomfort and somatic dissonance that constantly reassert the boundary between user and machine. Finally, on a functional level, they enforce modality rigidity, being devices designed almost exclusively for dedicated VR/AR sessions, unable to transition gracefully into tools for augmented productivity or ambient computing.

What is required is a paradigmatic shift from the principle of sensory replacement to the principle of sensory integration and augmentation. The ideal system would not seek to blind and deafen the user to the physical world but would allow their innate biological sensors (the most advanced and nuanced ever developed) to remain active and primary. The digital overlay should engage only when contextually required, appearing on command and retracting when not needed, allowing the brain to operate in its preferred state of environmental synthesis. This system must be ergonomically conceived as a weight-distributing, physiologically harmonious platform that disappears from somatic awareness, like comfortable clothing or eyeglasses. Its audio subsystem must be dynamic and convertible, allowing for either private immersion or integrated environmental listening. It must respect the brain's need for multi-modal confirmation and agency, leveraging, not bypassing, the body's senses. And ultimately, it must be functionally fluid, serving not only as an immersive portal but also as a practical, adaptive computing interface that can transition from a wearable headset to a responsive tabletop display, aligning its modality with the user's immediate task and cognitive state. The present invention addresses this comprehensive set of challenges through a novel integration of motorized articulation, dynamic stabilization, convertible audio, and dual-mode operation, creating the first head-mounted system designed for cognitive compatibility and ergonomic sustainability.

### SUMMARY OF THE INVENTION

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

The present disclosure describes a multi-modal virtual reality headset system engineered for ergonomic wearability and versatile functionality. The core apparatus comprises a curved, head-conforming housing that supports a pair of motorized, articulating arms. A key innovation is the synchronized, opposite-direction movement of a primary display frame and a counterbalancing protective visor, driven by an integrated motor and gear system, which enhances stability and comfort during use.

The system integrates a convertible audio subsystem featuring sliding speaker pods that also function as charging cases for wireless earbuds. A comprehensive array of environmental and user-tracking sensors, including gyroscopes and accelerometers, enables intelligent features such as automatic adjustment of the headband for a secure fit and hands-free orientation of the display in a dedicated tabletop operating mode.

Further aspects include a modular top unit for auxiliary functions, a dedicated active cooling system, and a specialized portable case that provides storage, transport, and charging for the entire system and its accessories. The design prioritizes cognitive compatibility by allowing natural sensory awareness until immersive interaction is intentionally engaged, aiming to bridge the gap between advanced digital immersion and sustainable human-centered ergonomics.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is an exploded view of a virtual reality headset, consistent with one or more exemplary embodiments of the present disclosure.

FIG. 2 shows the virtual reality headset with two movable speakers that have earphones installed inside, consistent with one or more exemplary embodiments of the present disclosure.

FIG. 3 illustrates the position of internal speakers and how to use and remove them, consistent with one or more exemplary embodiments of the present disclosure.

FIG. 4 shows how to place the speakers in a headset case, consistent with one or more exemplary embodiments of the present disclosure.

FIG. 5 shows how to close an arm of an LCD monitor with a protective wire, which is done with the help of a motor and gear, consistent with one or more exemplary embodiments of the present disclosure.

FIG. 6 illustrates movement of an LCD toward a user's face, consistent with one or more exemplary embodiments of the present disclosure.

FIG. 7 shows the location of sensors, camera lenses, and an LED light on the headset, consistent with one or more exemplary embodiments of the present disclosure.

FIG. 8 shows how to place virtual reality glasses on a user's nose and adjust an angle of the virtual reality glasses to the user's nose, consistent with one or more exemplary embodiments of the present disclosure.

FIG. 9 shows a position and mechanism of headset handle angles with the help of a motor, lever, and gear, consistent with one or more exemplary embodiments of the present disclosure.

FIG. 10 shows closure of a headset case, a movable screen, and a movable protective cover, consistent with one or more exemplary embodiments of the present disclosure.

FIG. 11 shows a virtual reality headset placed inside a portable protective bag, consistent with one or more exemplary embodiments of the present disclosure.

FIG. 12 shows positions of case cooling and an air outlet, consistent with one or more exemplary embodiments of the present disclosure.

FIG. 13 shows a position of a battery source and a module on the headset, consistent with one or more exemplary embodiments of the present disclosure.

FIG. 14 shows touch positions of a display frame together with an electronic pen, consistent with one or more exemplary embodiments of the present disclosure.

FIG. 15 shows a position of the headset on a table, consistent with one or more exemplary embodiments of the present disclosure.

FIG. 16 shows a screen with flexible capability on a headset case and how it is used by a user, consistent with one or more exemplary embodiments of the present disclosure.

FIG. 17 illustrates how to use the headset on an operator and its sitting positions on a user's head, consistent with one or more exemplary embodiments of the present disclosure.

FIG. 18 shows a headset device along with movable speakers positioned on a user's head, consistent with one or more exemplary embodiments of the present disclosure.

FIG. 19 illustrates how to assemble arm handles of the headset device, a display frame, and a protective screen, as well as how to assemble the arm handles and the headset device along with the movable speakers, consistent with one or more exemplary embodiments of the present disclosure.

FIG. 20 shows electronic frame movement using touch and a movable speaker, consistent with one or more exemplary embodiments of the present disclosure.

FIG. 21 shows movement of the electronic frame with the help of an electronic pen, consistent with one or more exemplary embodiments of the present disclosure.

FIG. 22 shows movement of the electronic frame by the voice of a user, consistent with one or more exemplary embodiments of the present disclosure.

FIG. 23 shows movement of the electronic frame on a table using touch, consistent with one or more exemplary embodiments of the present disclosure.

FIG. 24 shows movement of the electronic frame on a table using the electronic pen, consistent with one or more exemplary embodiments of the present disclosure.

FIG. 25 shows movement of the electronic frame on a table with the help of a user's voice, consistent with one or more exemplary embodiments of the present disclosure.

FIG. 26 shows a view inside a headset case from a vertical perspective, consistent with one or more exemplary embodiments of the present disclosure.

FIG. 27 shows a number of sensors installed on a bottom of a headset case, consistent with one or more exemplary embodiments of the present disclosure.

FIG. 28 shows a side view of a headset case, consistent with one or more exemplary embodiments of the present disclosure.

FIG. 29 shows a side view of a headset case, consistent with one or more exemplary embodiments of the present disclosure.

FIG. 30 shows a bottom view of a headset case, consistent with one or more exemplary embodiments of the present disclosure.

FIG. 31 shows two connected boxes which are attached to a headset case arm, consistent with one or more exemplary embodiments of the present disclosure.

FIG. 32 shows a manner of vertical and circular rotation movement from an external box, consistent with one or more exemplary embodiments of the present disclosure.

FIG. 33 shows a vertical movement of an LCD, consistent with one or more exemplary embodiments of the present disclosure.

FIG. 34 shows a vertical movement of an LCD, consistent with one or more exemplary embodiments of the present disclosure. In an exemplary embodiment, the LCD is positioned in an LCD frame holder. In an exemplary embodiment, the LCD frame holder has moved vertically upward.

FIG. 35 shows an open position of the headset, consistent with one or more exemplary embodiments of the present disclosure.

FIG. 36 shows a closed position of the headset, consistent with one or more exemplary embodiments of the present disclosure.

FIG. 37 shows an example computer system in which an embodiment of the present disclosure, or portions thereof, may be implemented as computer-readable code, consistent with one or more exemplary embodiments of the present disclosure.

### DESCRIPTION OF THE INVENTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

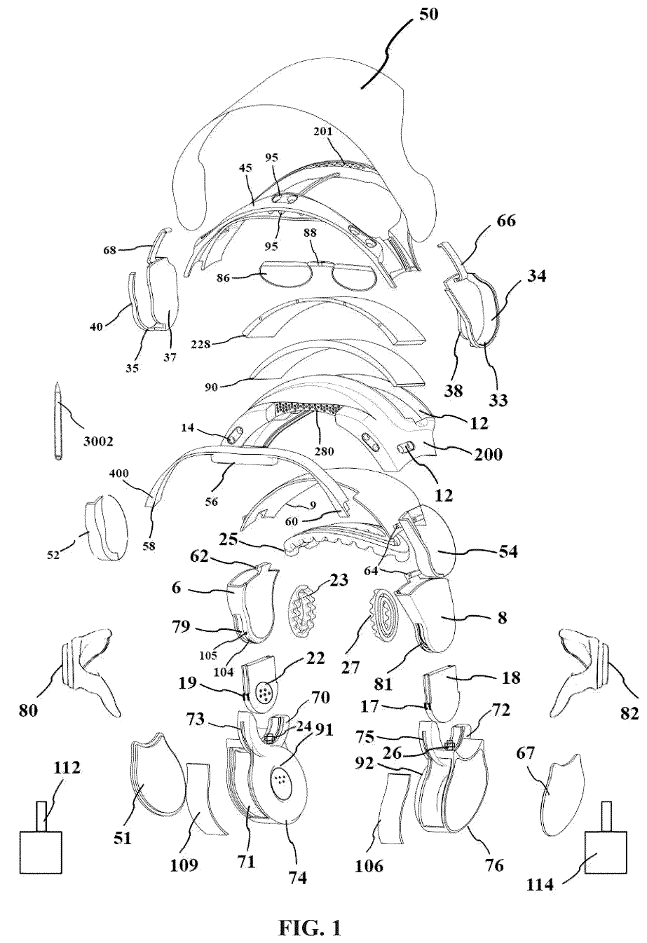

Disclosed herein is a virtual reality headset 100. FIG. 1 is an exploded view of a virtual reality headset, consistent with one or more exemplary embodiments of the present disclosure. In an exemplary embodiment, virtual reality headset 100 may include a curved rectangular cuboid box 200. In an exemplary embodiment, curved rectangular cuboid box 200 may be configured to sit on a user's head. In an exemplary embodiment, curved rectangular cuboid box 200 may include a front wall 16, a back wall 14, an upper wall 12, a first side handle 6, and a second side handle 8.

In an exemplary embodiment, virtual reality headset 100 may further include an electronic frame 300 with a touch display. In an exemplary embodiment, electronic frame 300 may be movably coupled to curved rectangular cuboid box 200. In an exemplary embodiment, virtual reality headset 100 may further include a protective visor 400. In an exemplary embodiment, protective visor 400 may be movably coupled to curved rectangular cuboid box 200. In an exemplary embodiment, virtual reality headset 100 may further include a first motor 112. In an exemplary embodiment, first motor 112 may be operatively connected to electronic frame 300 and protective visor 400.

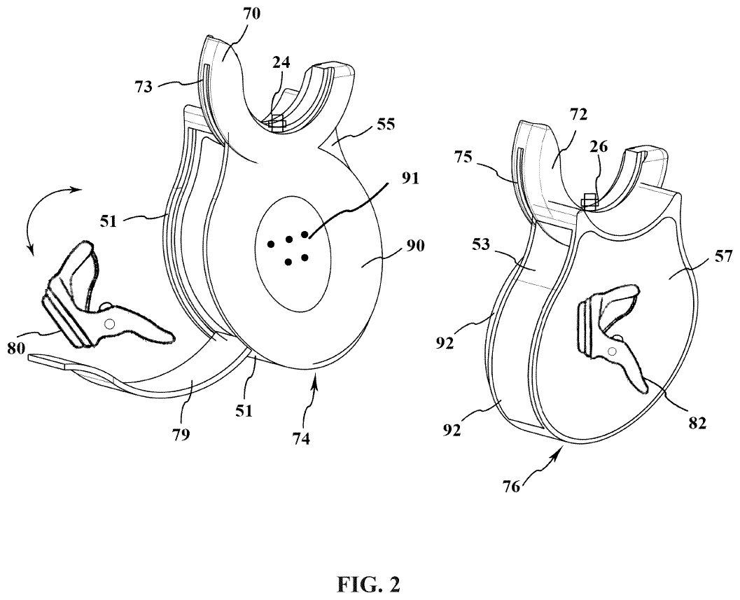

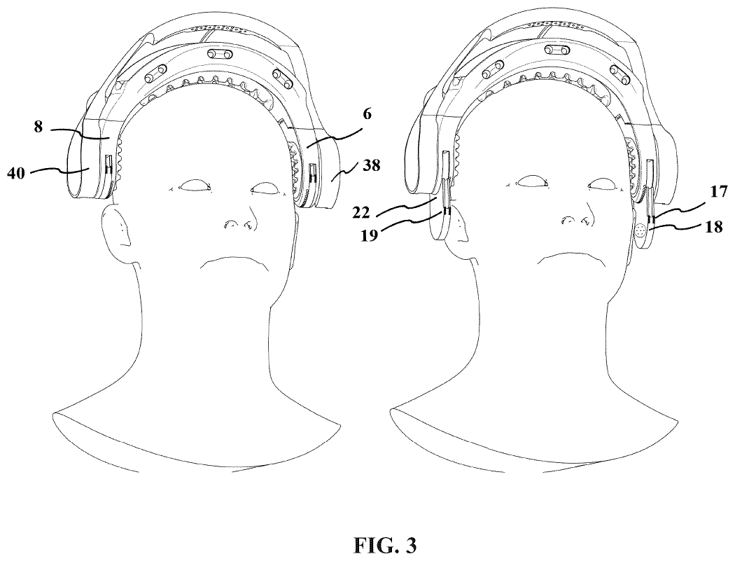

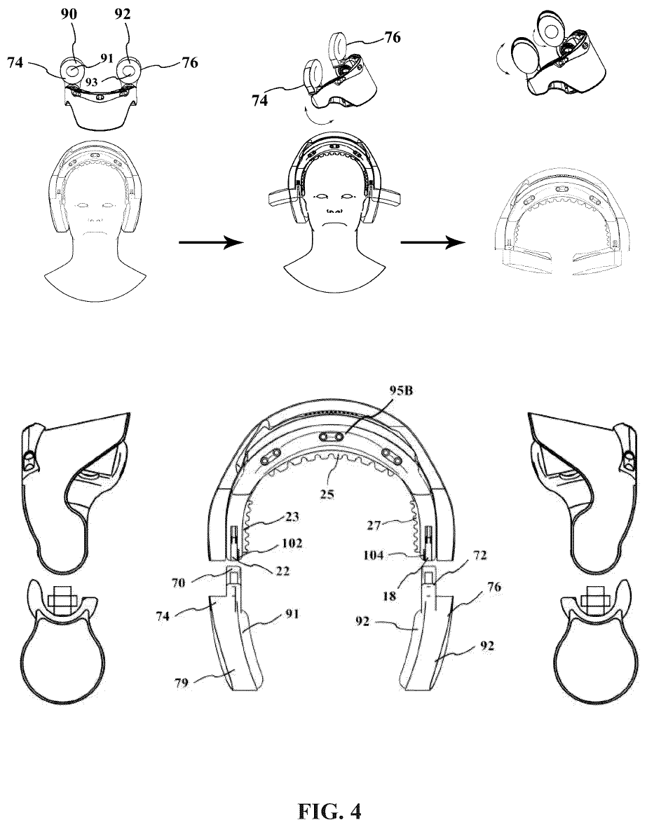

In an exemplary embodiment, virtual reality headset 100 may further include a second motor 114. In an exemplary embodiment, second motor 114 may be operatively connected to electronic frame 300 and protective visor 400. In an exemplary embodiment, virtual reality headset 100 may further include a first movable speaker box 74. FIG. 2 shows the virtual reality headset with two movable speakers that have earphones installed inside, consistent with one or more exemplary embodiments of the present disclosure. FIG. 3 illustrates the position of internal speakers and how to use and remove them, consistent with one or more exemplary embodiments of the present disclosure. FIG. 4 shows how to place the speakers in a headset case, consistent with one or more exemplary embodiments of the present disclosure. In an exemplary embodiment, first movable speaker box 74 may be slidably attached to first side handle 6. In an exemplary embodiment, first movable speaker box 74 may be configured to house a first speaker 91. In an exemplary embodiment, first movable speaker box 74 may be configured to slide upward and downward along first side handle 6. In an exemplary embodiment, first movable speaker box 74 may be configured to house a first earphone 80. In an exemplary embodiment, first movable speaker box 74 may comprise a first hinged door 79 for inserting and removing first earphone 80.

In an exemplary embodiment, virtual reality headset 100 may further include a second movable speaker box 76. In an exemplary embodiment, second movable speaker box 76 may be slidably attached to second side handle 8. In an exemplary embodiment, second movable speaker box 76 may be configured to house a second speaker 93. In an exemplary embodiment, second movable speaker box 76 may be configured to slide upward and downward along second side handle 8. In an exemplary embodiment, second movable speaker box 76 may be configured to house a second earphone 82. In an exemplary embodiment, second movable speaker box 76 may comprise a second hinged door 78 for inserting and removing second earphone 82.

In an exemplary embodiment, virtual reality headset 100 may further include a gyroscope sensor and an accelerometer sensor. In an exemplary embodiment, the gyroscope sensor and the accelerometer sensor may be configured to detect movement of the user's head.

In an exemplary embodiment, curved rectangular cuboid box 200 may further include a rectangular cube module 220. In an exemplary embodiment, rectangular cube module 220 may be removably attached to upper wall 12 via spring clamps 222, 224. In an exemplary embodiment, rectangular cube module 220 may house at least one of a Bluetooth communication module, a blood pressure sensor, an additional display screen 232, control keys 236, and a supplemental battery.

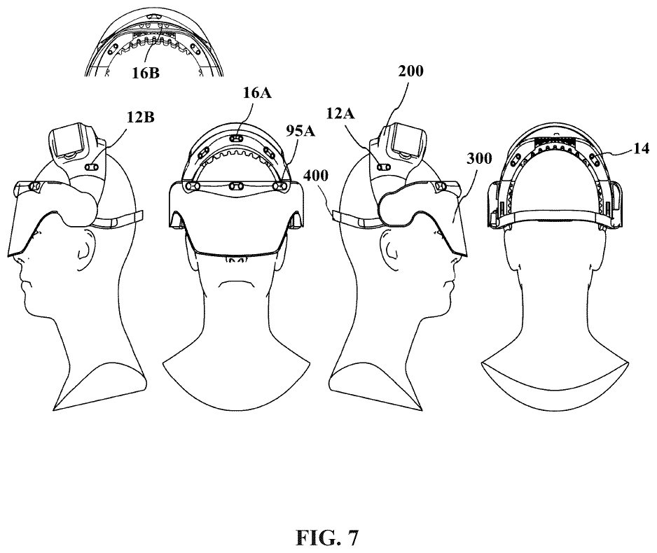

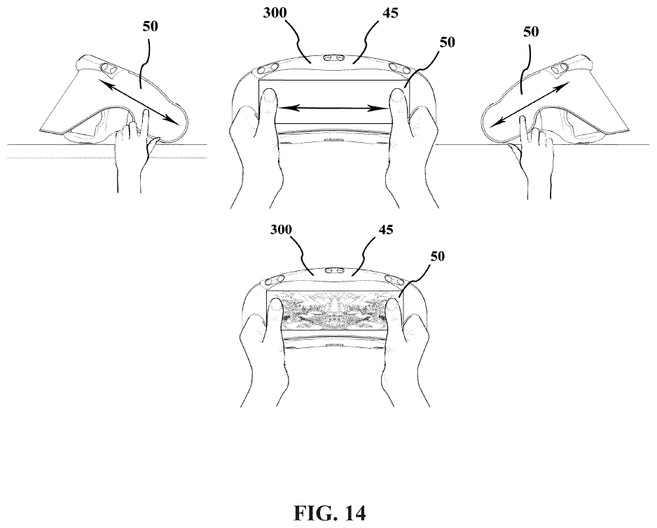

In an exemplary embodiment, virtual reality headset 100 may further include a plurality of sensors and camera lenses 96. In an exemplary embodiment, the plurality of sensors and camera lenses 96 may be disposed on at least front wall 16, back wall 14, and a back surface of electronic frame 300. In an exemplary embodiment, the plurality of sensors and camera lenses 96 may be configured to provide a 360-degree panoramic sensing capability for virtual and augmented reality. FIG. 7 shows the location of sensors, camera lenses, and an LED light on the headset, consistent with one or more exemplary embodiments of the present disclosure. In an exemplary embodiment, virtual reality headset 100 may further include an electronic pen. In an exemplary embodiment, the electronic pen may be configured to be stored in a dedicated box 201 on a lower part of electronic frame 300. In an exemplary embodiment, the electronic pen may be configured to provide touch input on the touch display. FIG. 14 shows touch positions of a display frame together with an electronic pen, consistent with one or more exemplary embodiments of the present disclosure.

In an exemplary embodiment, virtual reality headset 100 may further include a plurality of soft paddings 90, 92, 94. In an exemplary embodiment, the plurality of soft paddings 90, 92, 94 may be disposed on inner walls 2, 4, 10 of curved rectangular cuboid box 200 and on protective visor 400. In an exemplary embodiment, the plurality of soft paddings 90, 92, 94 may be configured to provide comfort and ventilation to the user's scalp.

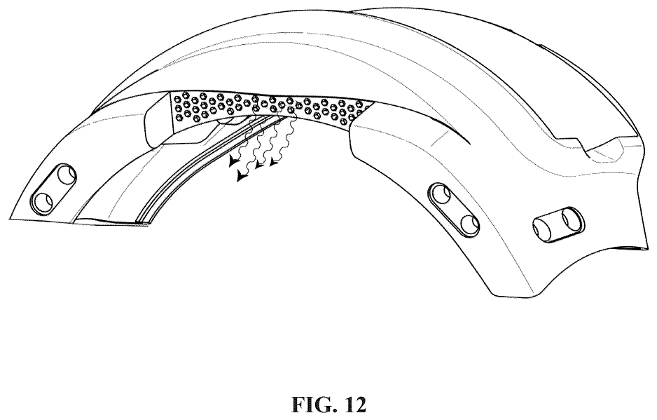

In an exemplary embodiment, virtual reality headset 100 may further include a cooling system. In an exemplary embodiment, the cooling system may comprise a plurality of air ducts in back wall 14. In an exemplary embodiment, the cooling system may comprise an electronic fan 280. In an exemplary embodiment, electronic fan 280 may be configured to cool electronic components within curved rectangular cuboid box 200. FIG. 12 shows positions of case cooling and an air outlet, consistent with one or more exemplary embodiments of the present disclosure.

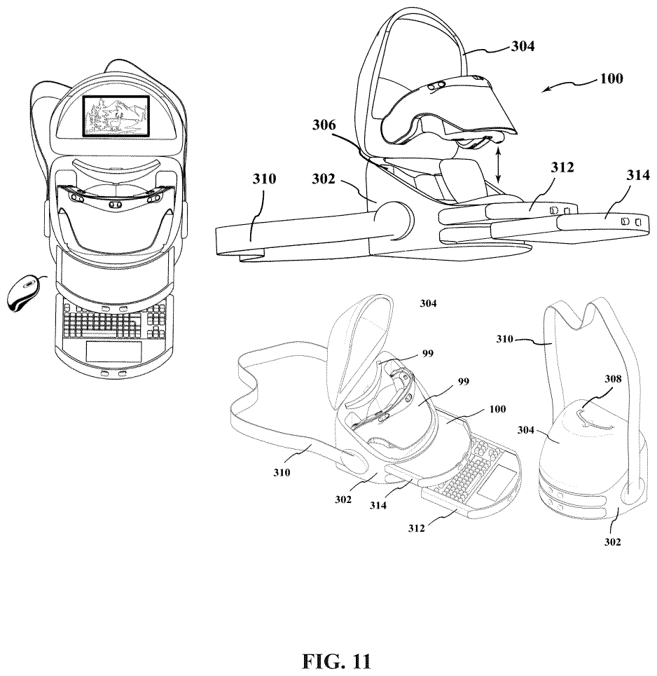

In an exemplary embodiment, virtual reality headset 100 may further include a portable protective case 302. In an exemplary embodiment, portable protective case 302 may comprise a body, a lid 304, a handle 308, a strap 310, a first removable drive layer 312, and a second removable drive layer 314. FIG. 11 shows a virtual reality headset placed inside a portable protective bag, consistent with one or more exemplary embodiments of the present disclosure.

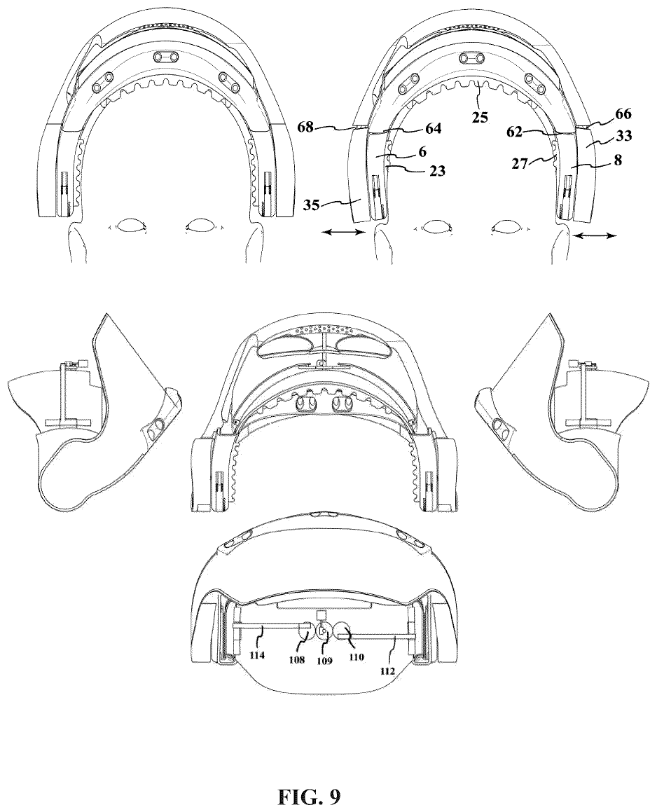

In an exemplary embodiment, first motor 112 and second motor 114 may be operatively connected to the gyroscope sensor and the accelerometer sensor. In an exemplary embodiment, first motor 112 and second motor 114 may be configured to adjust an angle of first side handle 6 and second side handle 8 via a first hinge 62 and a second hinge 64 to prevent virtual reality headset 100 from falling off the user's head. FIG. 9 shows a position and mechanism of headset handle angles with the help of a motor, lever, and gear, consistent with one or more exemplary embodiments of the present disclosure.

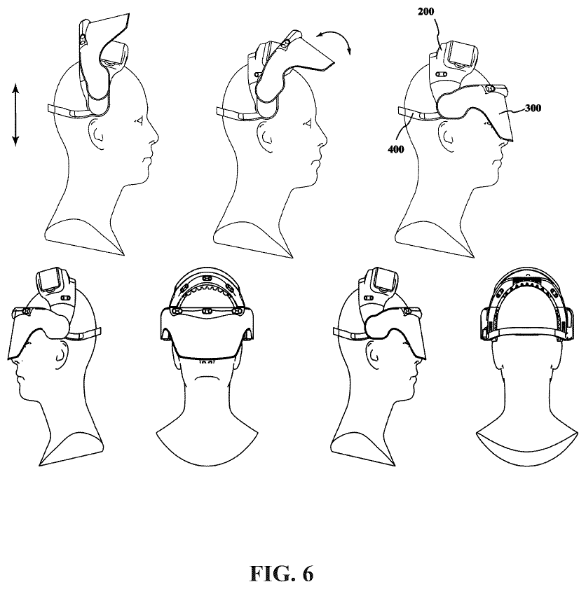

In an exemplary embodiment, first motor 112 and second motor 114 may be configured to move electronic frame 300 in a circular axial motion from a first stowed position on upper wall 12 of curved rectangular cuboid box 200 to a second deployed position in front of the user's face. In an exemplary embodiment, first motor 112 and second motor 114 may be configured to simultaneously move protective visor 400 in an opposite circular axial motion from the first stowed position to a third position behind the user's head, thereby providing counterbalancing stability. FIG. 6 illustrates movement of an LCD toward a user's face, consistent with one or more exemplary embodiments of the present disclosure.

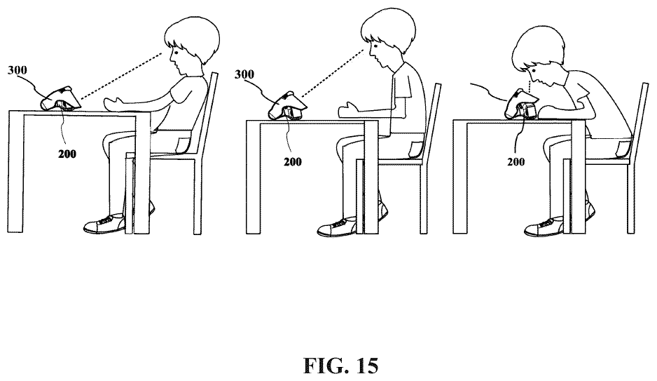

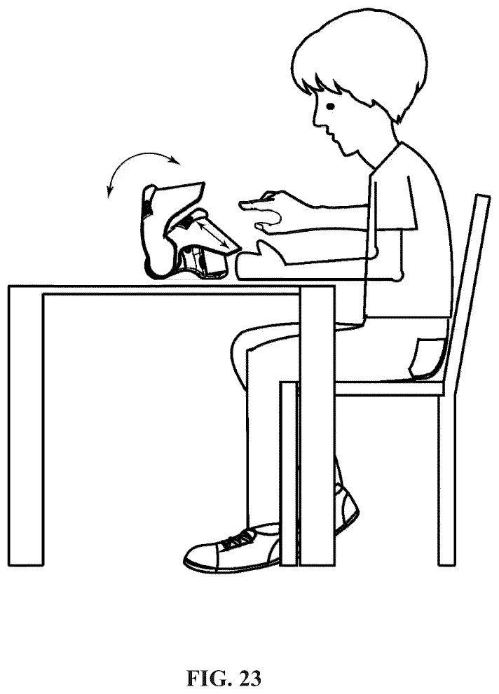

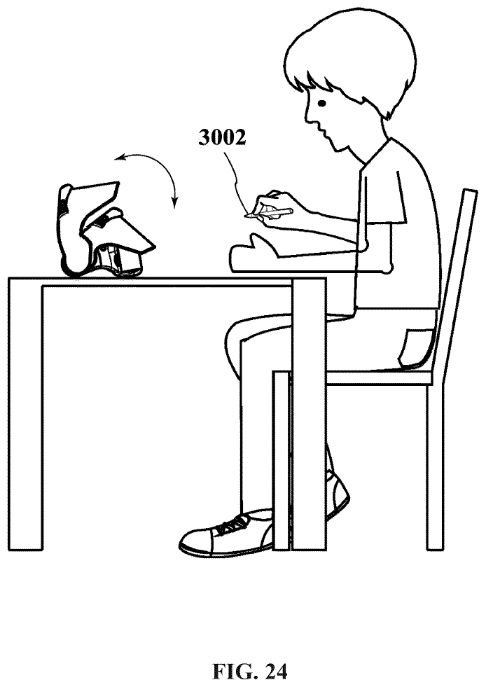

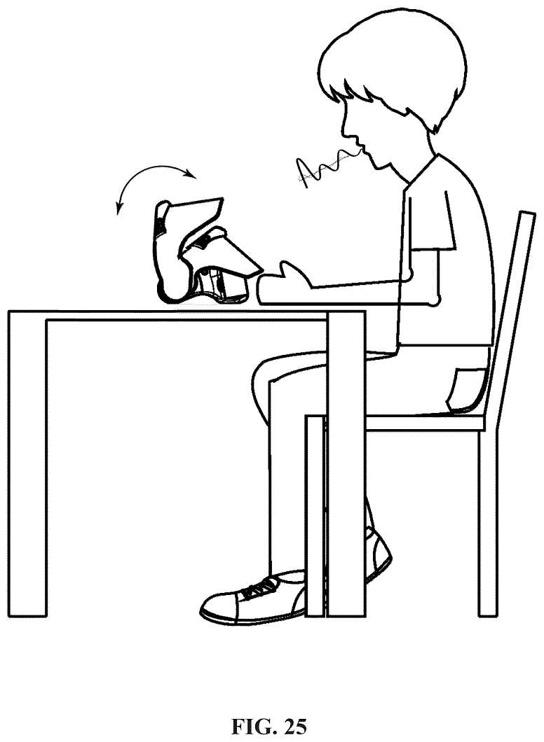

In an exemplary embodiment, virtual reality headset 100 may be configured to operate in a tabletop mode when placed on a surface. In an exemplary embodiment, in the tabletop mode, first motor 112 and second motor 114 may be configured to move electronic frame 300 based on input from at least one of an eye-tracking sensor, a touch command on electronic frame 300, a manual force, a command from the electronic pen, or a voice command, thereby orienting the touch display toward the user. FIG. 15 shows a position of the headset on a table, consistent with one or more exemplary embodiments of the present disclosure. FIG. 23 shows movement of the electronic frame on a table using touch, consistent with one or more exemplary embodiments of the present disclosure. FIG. 24 shows movement of the electronic frame on a table using the electronic pen, consistent with one or more exemplary embodiments of the present disclosure. FIG. 25 shows movement of the electronic frame on a table with the help of a user's voice, consistent with one or more exemplary embodiments of the present disclosure.

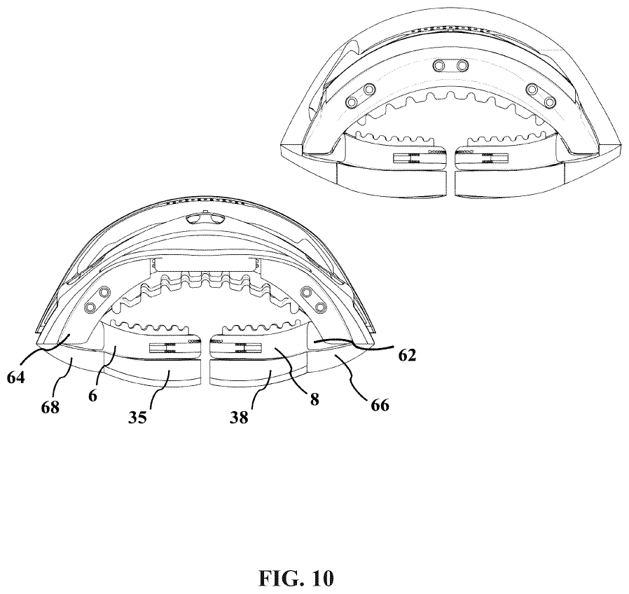

In an exemplary embodiment, first side handle 6 may be pivotable via first hinge 62 to fold inwardly toward a bottom of curved rectangular cuboid box 200. In an exemplary embodiment, second side handle 8 may be pivotable via second hinge 64 to fold inwardly toward the bottom of curved rectangular cuboid box 200. In an exemplary embodiment, electronic frame 300 and protective visor 400 may be configured to fold concurrently with first side handle 6 and second side handle 8. FIG. 10 shows closure of a headset case, a movable screen, and a movable protective cover, consistent with one or more exemplary embodiments of the present disclosure.

In an exemplary embodiment, first side handle 6, second side handle 8, electronic frame 300, and protective visor 400 may each utilize a separate spring coil for their folding movement.

In an exemplary embodiment, first movable speaker box 74 may comprise a first set of electronic connectors. In an exemplary embodiment, the first set of electronic connectors may be configured to charge first earphone 80 when stored therein. In an exemplary embodiment, second movable speaker box 76 may comprise a second set of electronic connectors. In an exemplary embodiment, the second set of electronic connectors may be configured to charge second earphone 82 when stored therein.

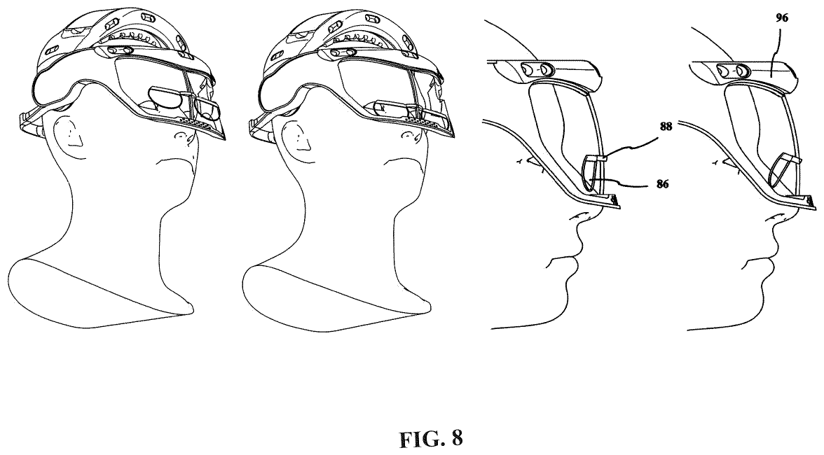

In an exemplary embodiment, electronic frame 300 may further comprise a pair of virtual reality glasses 86. In an exemplary embodiment, the pair of virtual reality glasses 86 may be mounted on the back surface of electronic frame 300. In an exemplary embodiment, the pair of virtual reality glasses 86 may be adjustable along a rail to align with the user's eyes. FIG. 8 shows how to place virtual reality glasses on a user's nose and adjust an angle of the virtual reality glasses to the user's nose, consistent with one or more exemplary embodiments of the present disclosure.

In an exemplary embodiment, first removable drive layer 312 and second removable drive layer 314 may be configured to store and transport virtual reality headset 100 and additional components. In an exemplary embodiment, the additional components may include first movable speaker box 74, second movable speaker box 76, and a keyboard.

In an exemplary embodiment, portable protective case 302 may comprise an internal battery. In an exemplary embodiment, the internal battery may be configured to charge virtual reality headset 100, first movable speaker box 74, and second movable speaker box 76.

In an exemplary embodiment, external walls 51, 59 of first movable speaker box 74 and second movable speaker box 76 may comprise a secondary touch and display screen. In an exemplary embodiment, the secondary touch and display screen may be configured to control operations of virtual reality headset 100.

In an exemplary embodiment, a plurality of sensors and camera lenses may be disposed on the back surface of electronic frame 300 above the pair of virtual reality glasses 86. In an exemplary embodiment, a plurality of sensors and camera lenses may be disposed on a top side of the touch display. In an exemplary embodiment, a pair of speakers and a microphone may be disposed on a lower side of electronic frame 300.

In an exemplary embodiment, electronic frame 300 may be designated as LCD frame 3000. In an exemplary embodiment, protective visor 400 may be designated as tele-protector 600.

In an exemplary embodiment, electronic frame 300 may comprise a first arm 34 and a second arm 40. In an exemplary embodiment, electronic frame 300 may comprise an inner first arm 36 and an inner second arm 38. In an exemplary embodiment, inner first arm 36 and inner second arm 38 may be connected to first side handle 6 and second side handle 8. In an exemplary embodiment, first arm 34 and second arm 40 may be connected to a main body of electronic frame 300 via a third hinge 66 and a fourth hinge 68.

In an exemplary embodiment, protective visor 400 may comprise a first visor arm 52 and a second visor arm 54. In an exemplary embodiment, first visor arm 52 may be connected to a main body of protective visor 400 via a fifth hinge 58. In an exemplary embodiment, second visor arm 54 may be connected to the main body of protective visor 400 via a sixth hinge 60. In an exemplary embodiment, protective visor 400 may comprise a central sponge cover 56.

In an exemplary embodiment, first movable speaker box 74 may be connected to first side handle 6 via a first rail clamp 70. In an exemplary embodiment, second movable speaker box 76 may be connected to second side handle 8 via a second rail clamp 72. In an exemplary embodiment, first rail clamp 70 may comprise a first spring clamp 77. In an exemplary embodiment, second rail clamp 72 may comprise a second spring clamp 76. In an exemplary embodiment, first movable speaker box 74 may connect to a first electronic connector 75. In an exemplary embodiment, second movable speaker box 76 may connect to a second electronic connector 73.

In an exemplary embodiment, first movable speaker box 74 may comprise an external wall 51, a wide wall 53, and an internal wall 55. In an exemplary embodiment, a first speaker sponge cover 90 may be configured between first speaker 91 and internal wall 55. In an exemplary embodiment, second movable speaker box 76 may comprise an external wall 59 and an internal wall 61. In an exemplary embodiment, a second speaker sponge cover 92 may be configured between second speaker 93 and internal wall 61.

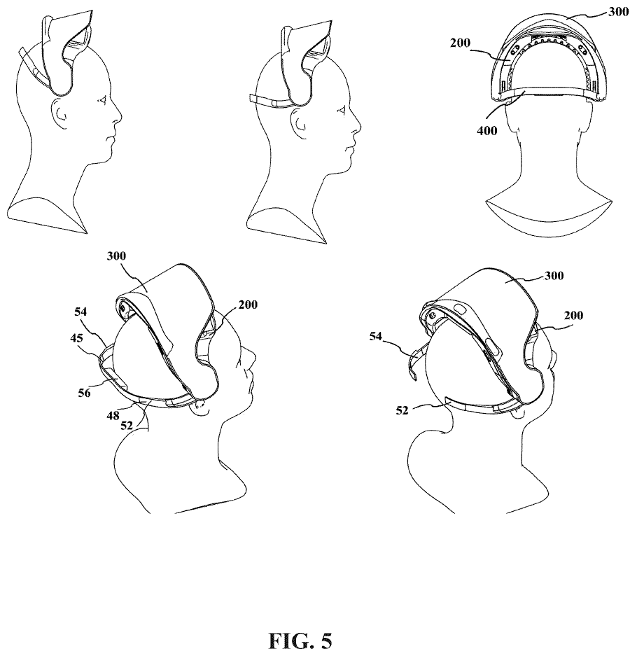

In an exemplary embodiment, virtual reality headset 100 may further comprise a third motor 106. FIG. 5 shows how to close an arm of an LCD monitor with a protective wire, which is done with the help of a motor and gear, consistent with one or more exemplary embodiments of the present disclosure. In an exemplary embodiment, third motor 106 may be configured to provide mechanical force. In an exemplary embodiment, a first gear 108 and a second gear 110 may be operatively connected to third motor 106. In an exemplary embodiment, the mechanical force from third motor 106 may be transmitted to first hinge 62 and second hinge 64 via first gear 108, second gear 110, first lever 112, and second lever 114.

In an exemplary embodiment, curved rectangular cuboid box 200 may comprise an inner first shell 2 and an inner second shell 4. In an exemplary embodiment, inner first shell 2 may be connected to first hinge 62. In an exemplary embodiment, inner second shell 4 may be connected to second hinge 64. In an exemplary embodiment, mechanical force from first lever 112 and second lever 114 may be transmitted to inner first shell 2 and inner second shell 4 to adjust an angle of first side handle 6 and second side handle 8.

In an exemplary embodiment, motors 112 and 114 may be configured within a body of first side handle 6 and second side handle 8. In an exemplary embodiment, a first fixed position may be prepared for first motor 112. In an exemplary embodiment, a second fixed position may be prepared for second motor 114.

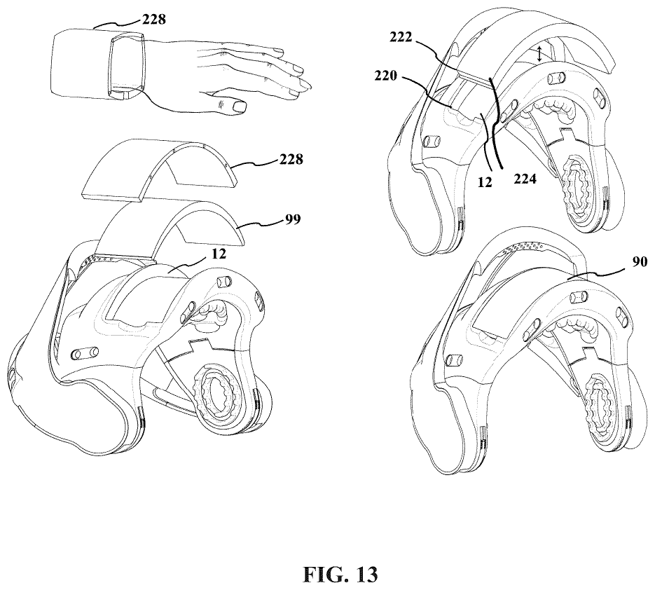

In an exemplary embodiment, rectangular cube module 220 may comprise a lower wall part 221. In an exemplary embodiment, lower wall part 221 may house electronic elements 228. In an exemplary embodiment, electronic elements 228 may comprise a display part 230. In an exemplary embodiment, display part 230 may comprise a display screen 232, a module speaker 234, and an electronic socket 238. In an exemplary embodiment, display part 230 may be held within rectangular cube module 220 by a module clamp 231. FIG. 13 shows a position of a battery source and a module on the headset, consistent with one or more exemplary embodiments of the present disclosure.

In an exemplary embodiment, a plurality of air holes and ducts 105 may be configured in a lower wall 10 of curved rectangular cuboid box 200. In an exemplary embodiment, electronic fan 280 may be configured to move air through the plurality of air holes and ducts 105.

In an exemplary embodiment, portable protective case 302 may comprise an interior space 306. In an exemplary embodiment, interior space 306 may be configured for maintenance of virtual reality headset 100. In an exemplary embodiment, portable protective case 302 may comprise a strap lock 312. In an exemplary embodiment, portable protective case 302 may comprise a strap adjustment 312. In an exemplary embodiment, portable protective case 302 may be made from a light metal alloy 319.

In an exemplary embodiment, virtual reality headset 100 may be configurable in a plurality of mechanical embodiments. In an exemplary embodiment, in a first embodiment, electronic frame 300 and protective visor 400 may be moved simultaneously by motor force. In an exemplary embodiment, in a second embodiment, protective visor 400 may remain behind the user's head when electronic frame 300 is returned to the first stowed position. In an exemplary embodiment, in the second embodiment, protective visor 400 may be manually returned to the first stowed position. In an exemplary embodiment, in a third embodiment, electronic frame 300 may be moved manually from the first stowed position to the second deployed position.

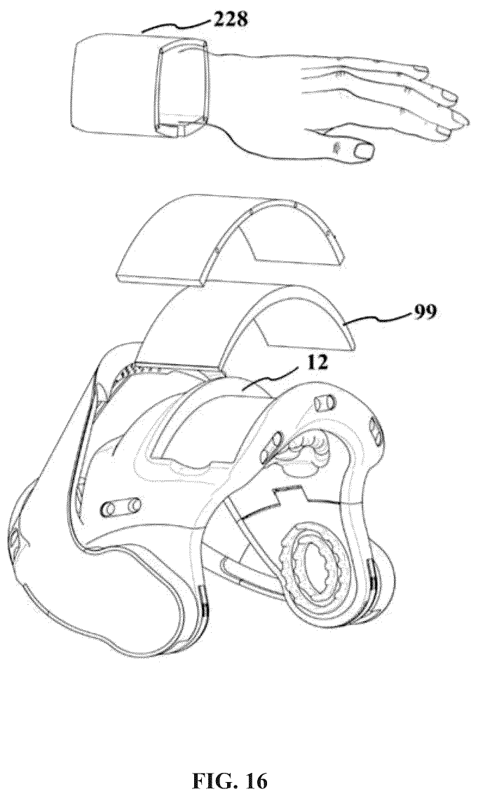

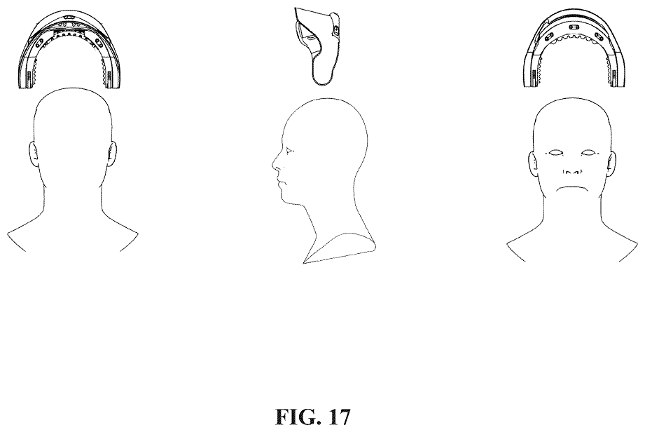

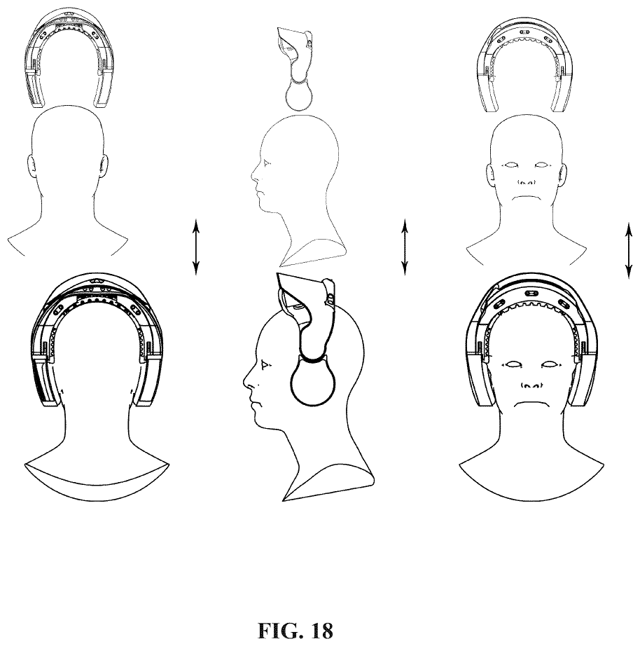

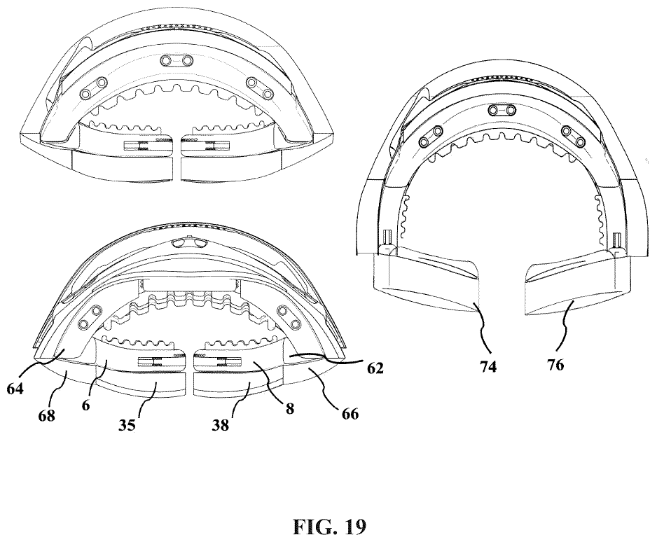

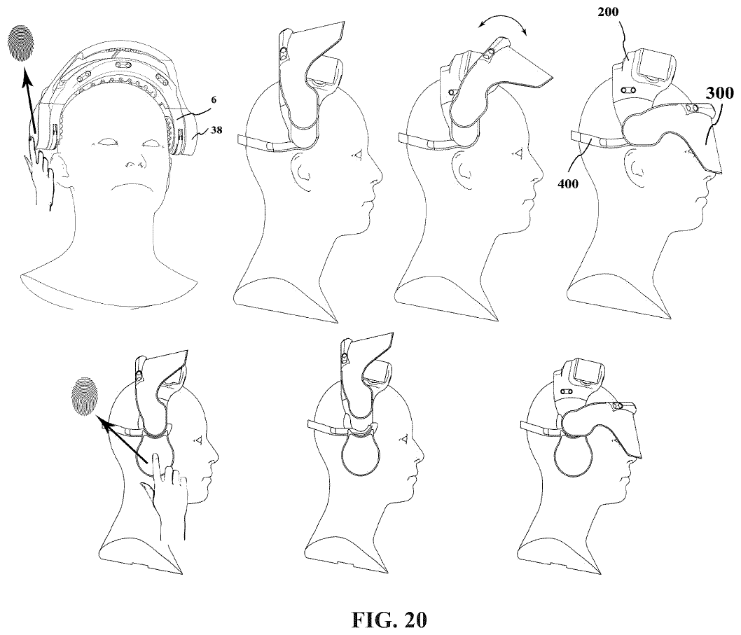

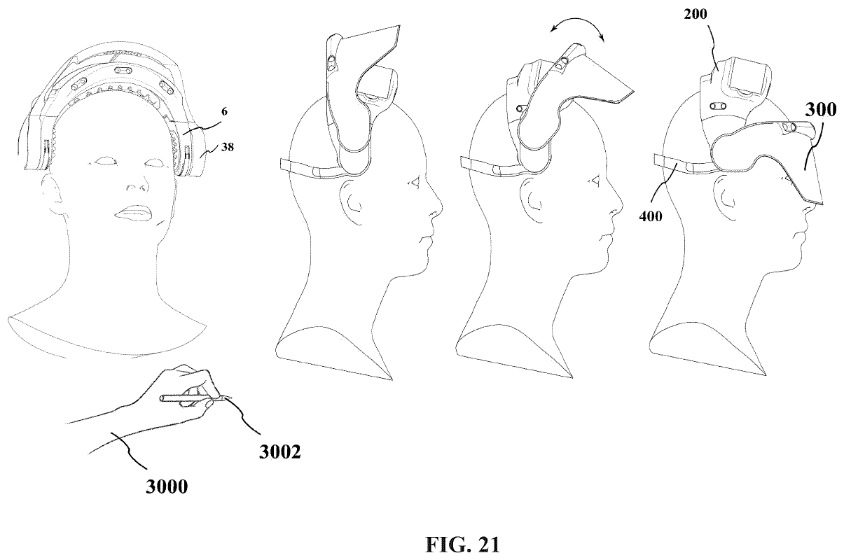

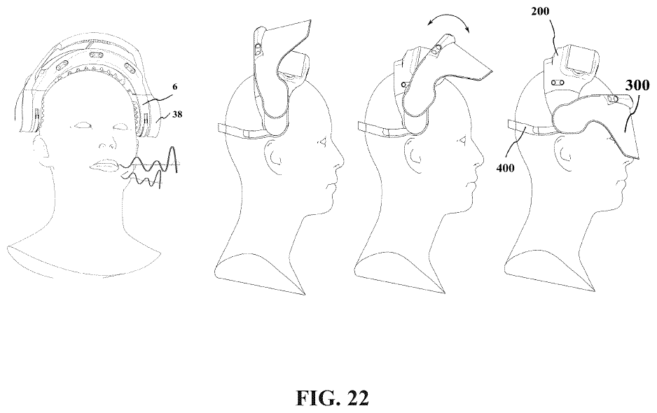

FIG. 16 shows a screen with flexible capability on a headset case and how it is used by a user, consistent with one or more exemplary embodiments of the present disclosure. FIG. 17 illustrates how to use the headset on an operator and its sitting positions on a user's head, consistent with one or more exemplary embodiments of the present disclosure. FIG. 18 shows a headset device along with movable speakers positioned on a user's head, consistent with one or more exemplary embodiments of the present disclosure. FIG. 19 illustrates how to assemble arm handles of the headset device, a display frame, and a protective screen, as well as how to assemble the arm handles and the headset device along with the movable speakers, consistent with one or more exemplary embodiments of the present disclosure. FIG. 20 shows electronic frame movement using touch and a movable speaker, consistent with one or more exemplary embodiments of the present disclosure. FIG. 21 shows movement of the electronic frame with the help of an electronic pen, consistent with one or more exemplary embodiments of the present disclosure. FIG. 22 shows movement of the electronic frame by the voice of a user, consistent with one or more exemplary embodiments of the present disclosure.

In an exemplary embodiment, the headset case may have a battery source and module 99. In an exemplary embodiment, battery source and module 99 may be installed on headset case upper wall 12. In an exemplary embodiment, the headset case may have a back wall 14 and a front wall 16. In an exemplary embodiment, a cover under a shoulder 9 may be provided. In an exemplary embodiment, a soft cover 25 may be provided. In an exemplary embodiment, the cover under shoulder 9 and soft cover 25 may be responsible for the sitting position of the user's head. In an exemplary embodiment, the headset case may have two arms 6 and 8. In an exemplary embodiment, arms 6 and 8 may be supported by two spring hinges 62 and 64. In an exemplary embodiment, arms 6 and 8 may be attached to a main body of the headset case via spring hinges 62 and 64.

In an exemplary embodiment, in arms 6 and 8 of the headset case, positions of an LCD frame may be connected to numbers 36 and 38 by a rotating motor. In an exemplary embodiment, a wire may be mechanically connected to the motor. In an exemplary embodiment, bases 52 and 54 inside the LCD frame may be connected to motors 112 and 114.

In an exemplary embodiment, the headset case may be designated as number 200. In an exemplary embodiment, the LCD frame may be designated as number 3000. In an exemplary embodiment, a phone protector may be designated as number 400.

In an exemplary embodiment, at an end of arms 8 and 6 of the headset case, two clamps with dials 70 and 72 may be connected. In an exemplary embodiment, clamps 70 and 72 may be connected in a form of a clip. In an exemplary embodiment, rail clamps 70 and 72 may be followed by speaker boxes 74 and 76.

In an exemplary embodiment, at the end of arms 6 and 8 of the headset case, there may be two hidden speakers 18 and 22. In an exemplary embodiment, hidden speakers 18 and 22 may be embedded in appendages 17 and 19 respectively through extra parts. In an exemplary embodiment, appendages 17 and 19 may be connected to speakers 18 and 20 respectively. In an exemplary embodiment, appendages 17 and 19 may allow a user to slide a position of speakers 18 and 20 downwards and upwards by means of clips.

In an exemplary embodiment, speakers 18 and 20 may be able to transmit sound inside the end arms of the headset case through channels 102 and 104 respectively. In an exemplary embodiment, a position of a microphone to receive sound from private channels 102 and 105 respectively may be possible.

In an exemplary embodiment, an inner shell of arms of case 200 with numbers 2 and 4 may be connected to hinges 62 and 64 respectively. In an exemplary embodiment, inner shells 2 and 4 may create a position to transmit mechanical force produced by motor 106 with a help of levers 112 and 114 and also gears 110 and 108. In an exemplary embodiment, a CPU of headset device 200 through a module may create a position for headset device 200 to prevent movements and shakes. In an exemplary embodiment, a visualization of motor 106 by moving gears 108 and 110 may apply pressure to levers 114 and 112. In an exemplary embodiment, through levers 112 and 114, angles of hinges 62 and 64 may be opened and closed. In an exemplary embodiment, inner shells 2 and 4 may be connected on another side of hinges 62 and 64. In an exemplary embodiment, this connection may cause an arm to close an angle of case 200 handles. In an exemplary embodiment, inside a body of an LCD frame of a display 300, both motors 112 and 114 may provide an ability to move in headset case 200 in different directions.

In an exemplary embodiment, an LCD frame 300 and a protective cover 400 may be placed in one mold and one shape inside another. In an exemplary embodiment, this position may be in an off state. In an exemplary embodiment, after a user applies a start command to a CPU of the headset device, a screen frame 300 and a tele-protector 600 may move with a help of power transmission of motors 112 and 114 and also gears 116 and 118 in an opposite direction and angles. In an exemplary embodiment, the display frame 300 and the tele-protector 400 may come off. In an exemplary embodiment, headset case 200 may remain motionless in its place. In an exemplary embodiment, motors 114 and 112 may be configured in a body of arms of the headset case. In an exemplary embodiment, a fixed position may be prepared for a motor position.

In an exemplary embodiment, display frame 300 may move in front of a user's face and protective cover 400 may move behind the user's head. In an exemplary embodiment, the display may move in a first movement upwards and then in a circular axial motion towards a front of the user's face.

In an exemplary embodiment, when display frame 300 is returned from a front face to a top of headset case 200, display frame 300 and protective cover 400 may move towards each other at a same time. In an exemplary embodiment, both display frame 300 and protective cover 400 may be placed in a same frame on a same position on headset case 200.

In an exemplary embodiment, in another embodiment, display frame 300 may move back when a motor moves to a first house. In an exemplary embodiment, headset case 200 may move back. In an exemplary embodiment, protective cover 400 may remain in a same position behind a head. In an exemplary embodiment, a user may manually direct and place tele-protector 400 to the first house on headset case 200 with a help of hand strength.

In an exemplary embodiment, in another embodiment, display frame 300 and tele-protector 400 may both be moved to the first house on headset case 200 at a same time by a motor force.

In an exemplary embodiment, in another embodiment, display frame 300 may perform its movements manually from a stage of the first house on headset case 200 until a time when display frame 300 is placed in front of a user's face.

In an exemplary embodiment, a case headset 200 device may have motors 112 and 114. In an exemplary embodiment, force may be applied by a user's hand manually. In an exemplary embodiment, a user may manually move movements of display frame 300 and a protective wire 400. In an exemplary embodiment, case headset 200 may have no motion motor. In an exemplary embodiment, case headset 200 may perform movements of frame 300 and cover 400 only with a help of a user's hand with a manual mechanism.

In an exemplary embodiment, in another embodiment, a position of protective shield 400 inside display frame 300 may not be configured to occupy less space. In an exemplary embodiment, in this embodiment, display frame 300 may be moved behind a user's head.

In an exemplary embodiment, due to movement of display 300 and tele-protector 400 towards a back of headset case 200 with circular movement, this position of movement may be only in a use of a headset by a user on a table.

In an exemplary embodiment, a headset device may be placed on a table. In an exemplary embodiment, a user may use sensors located on display frame 300 to determine a face position or identify a user's eyes. In an exemplary embodiment, upward and downward movements may then be made with a help of a CPU and motors 112 and 114.

In an exemplary embodiment, in another embodiment, a user may move display frame 300 by hand to position a display at a right viewing angle. In an exemplary embodiment, arm handles of a headset may be moved towards each other. In an exemplary embodiment, this position may come with screen frame 300 and phone protector 400 and case 300 itself.

In an exemplary embodiment, it may be possible with a help of special spring hinges placed in headset case 200 and displayable 300 and protective cover 400. In an exemplary embodiment, a circular angle position may originate from an axis of headset case 200. In an exemplary embodiment, this may cause hinges of display frame 300 and protective cover 400 to move in a same position as headset case handles 200.

In an exemplary embodiment, display frame 300 along with tele-protector 400 may be placed in their position on headset case 200. In an exemplary embodiment, a predetermined position may be placed relative to hinges of 200, 300, 400. In an exemplary embodiment, a folding position and applying a force from 200 to 300 and from 300 to 400 may be applied.

In an exemplary embodiment, arms of headset case 200 may be numbered 6 and 8. In an exemplary embodiment, arms 6 and 8 may be connected by hinges 62 and 64 respectively. In an exemplary embodiment, on another side of hinges 62 and 64 on a body of the case, the headset may be connected to number 96.

In an exemplary embodiment, a frame of display 300 may have arms numbered 34 and 40 and numbered 36 and 38 from an inside. In an exemplary embodiment, arms 36 and 38 may go from an inner part to outer parts of headset case numbered 6 and 8. In an exemplary embodiment, in this connection, a position of motors 112 and 114 along with gears 116 and 118 may be configured. In an exemplary embodiment, arms of a display frame may be connected to a main body of the display frame at number 45 through hinges 66 and 68.

In an exemplary embodiment, arms of a tele-protector 400 may be numbered 52 and 54. In an exemplary embodiment, arms 52 and 54 may be connected to a main body of 400 through hinges 58 and 60 respectively. In an exemplary embodiment, in a center of tele-protector 400 there may be a cloud or sponge cover numbered 56. In an exemplary embodiment, cover 56 may allow a connection of protective cable 400 to be placed on a user's head smoothly.

In an exemplary embodiment, in another embodiment, cloud part 56 may be removed and placed together with a main body of protective shield 400 as a clip.

In an exemplary embodiment, speakers 22 and 18 may be placed at an end of arms 6 and 8 of a headset case. In an exemplary embodiment, speakers 22 and 18 may be pulled downwards and may be moved inside arms 6 and 8 in a spring-like manner. In an exemplary embodiment, this position may cause speaker boxes 74 and 76 to be connected to headset case arms 24 and 26 respectively with a help of parts 70 and 72 in a form of sliding clips.

In an exemplary embodiment, speaker boxes 74 and 76 with an axis of sliding parts 70 and 72 may be moved in different positions around headset case arms. In an exemplary embodiment, speaker box 76 may be configured to connect to numbers 75 and 73. In an exemplary embodiment, this connection may align an electronic and mechanical connection.

In an exemplary embodiment, in another embodiment, two earphones numbered 80 and 82 may be placed in movable speaker boxes 74 and 76 respectively. In an exemplary embodiment, in this position, two hinged doors numbered 79 and 78 may be placed on a side body of movable speaker boxes 74 and 76 respectively. In an exemplary embodiment, hinged doors 79 and 78 may enable placement of earphones 80 and 82 inside and out.

In an exemplary embodiment, positions of sliding parts 70 and 72 may have spring clamps numbered 76 and 77 respectively. In an exemplary embodiment, through their special positions numbered 79 and 81 respectively, which may be inside handles of case 200, a position of a mechanical clamp and an electronic connection may be provided for headsets, speaker boxes, and earphones.

In an exemplary embodiment, speaker box 76 may have an external wall number 61, a soft sponge cover number 92, and a speaker number 93. In an exemplary embodiment, speaker box 74 may have an external wall number 51, a wide wall number 53, an internal wall number 55, a sponge cover number 90, and a speaker number 91.

In an exemplary embodiment, an output part of speaker 91 may be configured to inner wall 55. In an exemplary embodiment, a sponge cover number 90 may have a position of leaning on a user's ear. In an exemplary embodiment, in width wall 53 there may be a sliding door number 79 for an internal purpose or an external phone call.

In an exemplary embodiment, an output part of speaker 93 may be configured to inner wall 61. In an exemplary embodiment, opposite to it, a sponge cover number 92 may be configured for a position of resting on a user's ear. In an exemplary embodiment, a door number 76 may be placed on a transverse wall. In an exemplary embodiment, door 76 may be configured to insert and remove earphone number 82.

In an exemplary embodiment, on external walls 51 and 59 of speaker boxes 74 and 76, a position may be visualized as a touch and display screen. In an exemplary embodiment, through speaker boxes 74 and 76 different positions such as control of the headset device may be provided. In an exemplary embodiment, virtual reality control positions of motors 112 and 114 and motor 106 and cooling positions 105 and everything related to headset device 100 may be in this device.

In an exemplary embodiment, it may also be possible to use positions such as telecommunication communication modules, a Bluetooth module, a Wi-Fi module, a battery source, an electronic pen position, a telecommunication module, a SIM card position.

In an exemplary embodiment, a display frame 300 may have a handle and arms that have outer walls numbered 34 and 40, width walls numbered 33 and 35 and inner walls numbered 36 and 38. In an exemplary embodiment, display frame 300 may have two spring and rail hinges 66 and 68. In an exemplary embodiment, display frame 300 may have a sensor and lens position and light flash. In an exemplary embodiment, sensors, lenses and light flash may be number 96. In an exemplary embodiment, a display and touch screen number 50 on an outer wall may be configured as number 46. In an exemplary embodiment, in an inner wall of number 42, there may be an adjustable height and fender position as number 88 and virtual reality glasses as number 86. In an exemplary embodiment, in a lower part of screen 50, there may be a special box for a position of electronic elements such as a microphone, a speaker, sensors and a lens, and an electronic pen configured as number 201.

In an exemplary embodiment, on a back side of a sensor and camera lens and light flash at number 95 and on a side of an inner wall of frame 300 at number 42, seven elements such as an eye and face lens sensor and camera lens, electronic elements of virtual reality control, and a projector may be configured. In an exemplary embodiment, a special position of number 96 in parts of a front wall of a headset case numbered 16, as well as in a back wall of a headset numbered 14 and an upper wall of a body numbered 12 may be configured to a 360 degree panoramic position for use in virtual and augmented reality.

In an exemplary embodiment, in an upper wall of a headset case number 12, there may be a rectangular cube part number 220. In an exemplary embodiment, rectangular cube part 220 may be fixed through spring clamps 222 and 224 for a purpose of mechanical and electronic communication. In an exemplary embodiment, part 220 may establish communication with a headset case.

In an exemplary embodiment, a location of place holders 222 and 224 in part 220 may be configured as number 226 and 228. In an exemplary embodiment, this configuration may allow a storage position and electronic communication to be established well. In an exemplary embodiment, number 221 may be placed on a lower wall part of piece 220. In an exemplary embodiment, number 221 may have a place for electronic elements number 228. In an exemplary embodiment, electronic elements 228 may include a Bluetooth communication module, a blood pressure and blood vessel module, a display screen, a speaker, a camera lens, a speaker, a battery source, a touch screen, and control keys.

In an exemplary embodiment, a display part 228, a body number 230, a display number 232, a speaker number 234, several control keys number 236, and an electronic socket number 238 may be configured. In an exemplary embodiment, body number 230 may sit in a form of a clamp inside part 220. In an exemplary embodiment, special clamps for number 231 may strengthen this position. In an exemplary embodiment, through an electronic socket position and electronic communication including charging a battery source, positions may be established with piece 220 and also through piece 220 with headset case 200.

In an exemplary embodiment, part 228 may have a body 230 with a flexible and hinged body. In an exemplary embodiment, a flexible display and touch can be configured. In an exemplary embodiment, inner walls of Case 200, numbers 2, 4, 10, may have a special soft cover. In an exemplary embodiment, orderer numbers 90, 92, and 94 may be responsible for a sitting position and placement of device 100 on a user's head. In an exemplary embodiment, a waveform such as cover 90, 92, 94, as well as positions of being placed on a user's head in order to weigh headset device 100, as well as different blood supply positions under a user's scalp and a temperature created by headset device 100 may be configured.

In an exemplary embodiment, a number of air holes and ducts may be considered in a lower wall at number 10 and a width wall at number 14. In an exemplary embodiment, an electronic fan at number 280 may be used in order to cool electronic elements and provide air conditioning inside case 200.

In an exemplary embodiment, a headset device 100 may have a portable protective case. In an exemplary embodiment, the portable protective case may have a handle, a strap, a strap lock and strap adjustment, a body and a body lid, several drive layers containing elements and electronic components.

In an exemplary embodiment, a body number 302, a body door number 304, two sliding drives and a floor respectively number 312, 314, a body handle number 308, a strap number 310, a lock and adjustment of the strap number 312 may be configured.

In an exemplary embodiment, an interior space numbered 306 may be responsible for maintenance and preservation of headset 100. In an exemplary embodiment, in lower floors, two or more floor drives may be configured. In an exemplary embodiment, floor drives may have various positions such as a battery source, moving speakers 76 and 74, a keyboard, and other electronic elements. In an exemplary embodiment, electronic elements may be placed in drive locations 312 and 314. In an exemplary embodiment, a wall material of 308 and 319 can be made from light metal alloys such as aluminum.

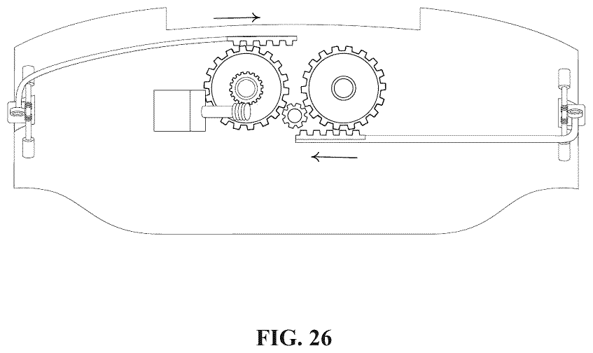

FIG. 26 shows a view inside a headset case from a vertical perspective, consistent with one or more exemplary embodiments of the present disclosure. In an exemplary embodiment, the view illustrates an internal motor and several gears. In an exemplary embodiment, two lever arms for applying pressure are installed. In an exemplary embodiment, at an end of the levers, each lever is connected to a specific spring-loaded hinge. In an exemplary embodiment, this connection is configured to perform a circular opening and closing motion of the headset arms.

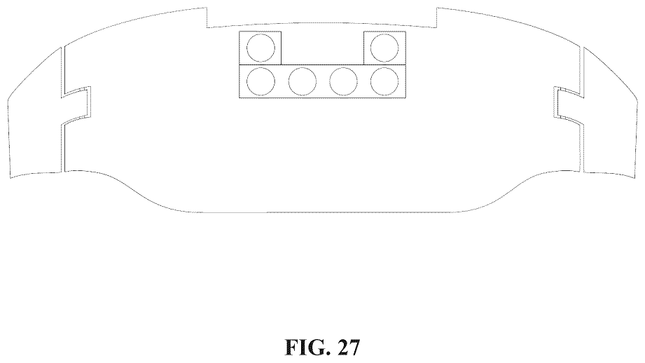

FIG. 27 shows a number of sensors installed on a bottom of a headset case, consistent with one or more exemplary embodiments of the present disclosure. In an exemplary embodiment, the sensors are configured to display various positions. In an exemplary embodiment, the various positions include a position of being placed on a user's head. In an exemplary embodiment, the various positions include a position of being placed on a table. In an exemplary embodiment, the various positions include gyroscope positions.

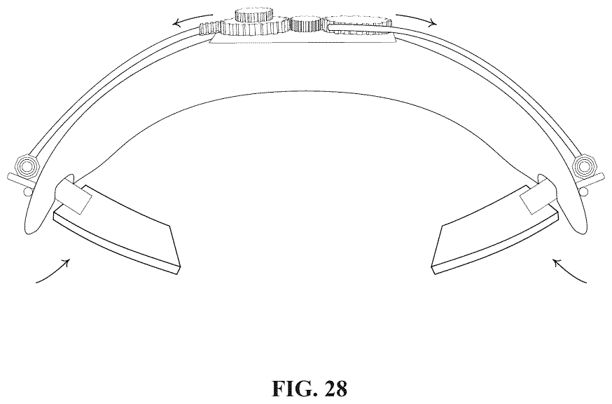

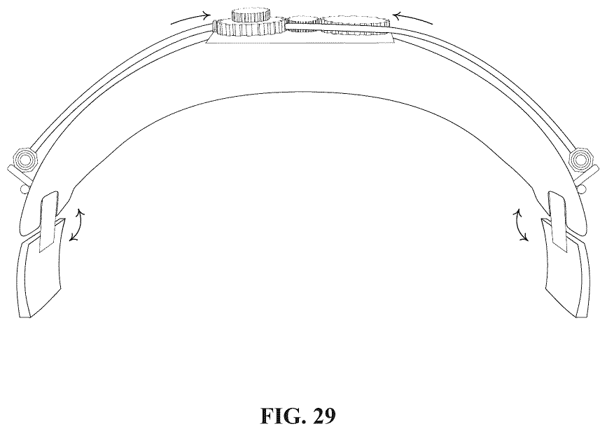

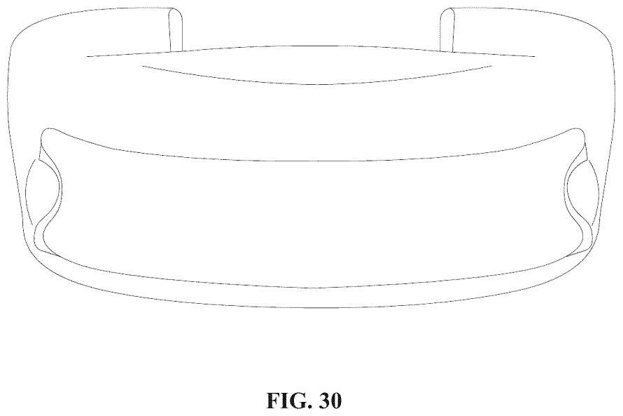

FIG. 28 shows a side view of a headset case, consistent with one or more exemplary embodiments of the present disclosure. In an exemplary embodiment, the side view displays gears and arms. In an exemplary embodiment, the side view also displays a movement of closing the arms. FIG. 29 shows a view similar to FIG. 28, consistent with one or more exemplary embodiments of the present disclosure. In an exemplary embodiment, the view displays a position of opening the arms. In an exemplary embodiment, the opening of the arms is displayed through levers and gears. FIG. 30 shows a bottom view of a headset case, consistent with one or more exemplary embodiments of the present disclosure.

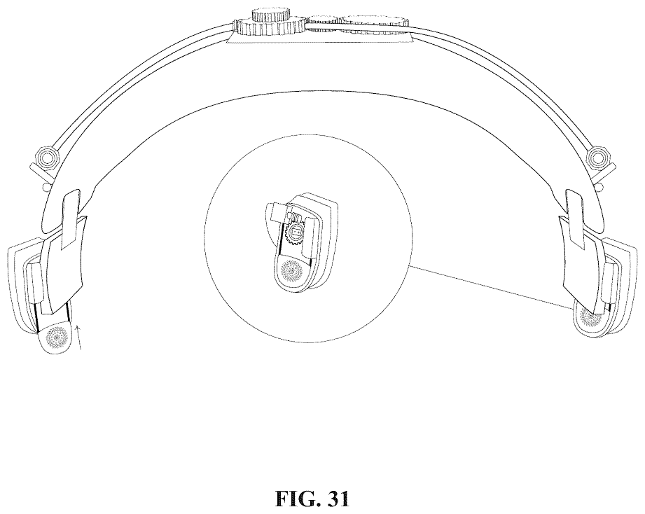

FIG. 31 shows two connected boxes which are attached to a headset case arm, consistent with one or more exemplary embodiments of the present disclosure. In an exemplary embodiment, inside these boxes, two motors, gears, and a speaker are present. In an exemplary embodiment, a vertical and circular movement of a touch LCD is performed through the motors inside the boxes.

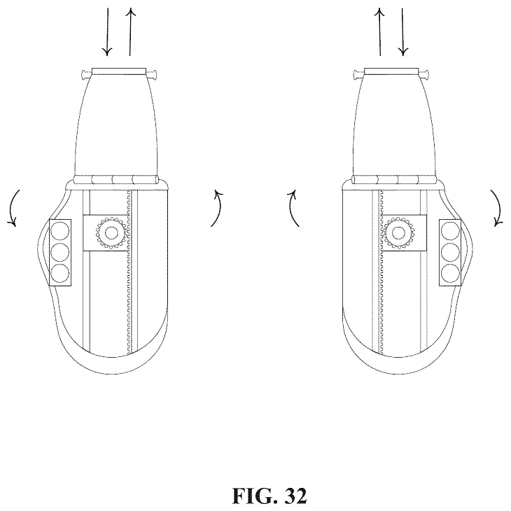

FIG. 32 shows a manner of vertical and circular rotation movement from an external box, consistent with one or more exemplary embodiments of the present disclosure. In an exemplary embodiment, a number of touch sensors are displayed. In an exemplary embodiment, the touch sensors are shown in a rectangular shape and three circles. In an exemplary embodiment, each touch sensor is positioned on one side of a movable LCD box arm.

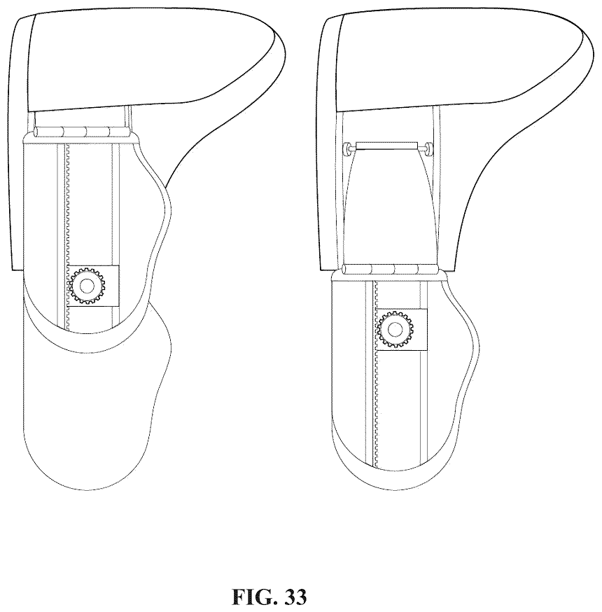

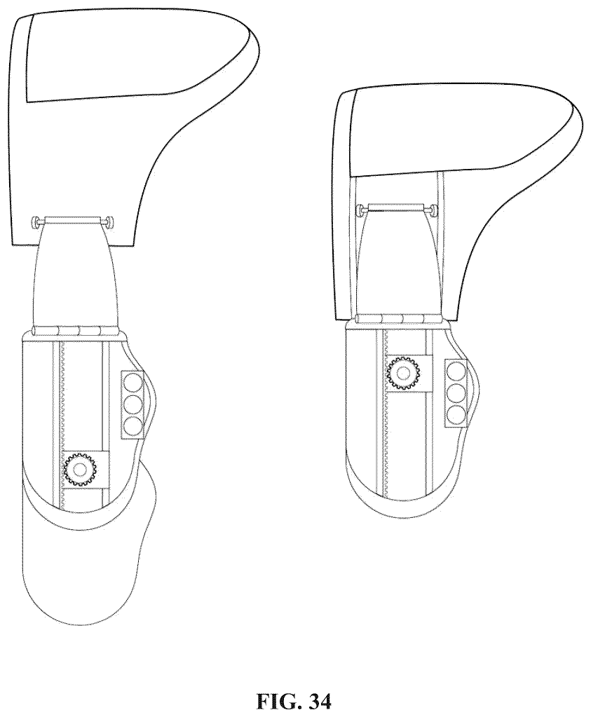

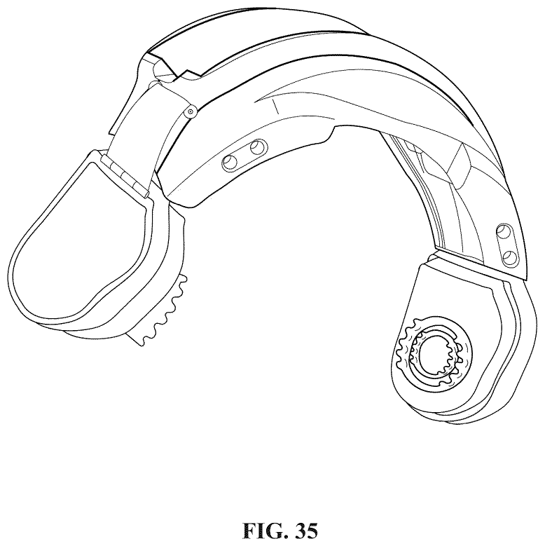

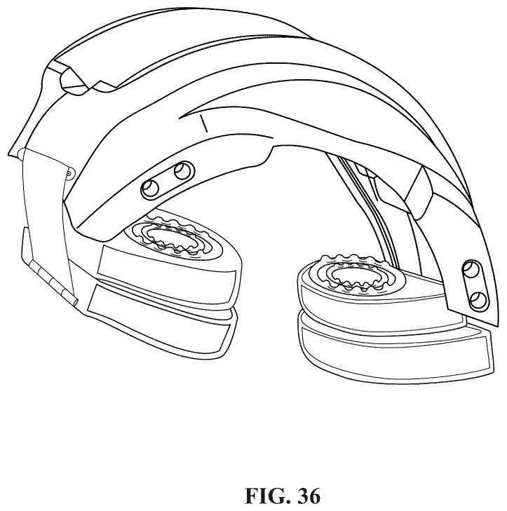

FIG. 33 shows a vertical movement of an LCD, consistent with one or more exemplary embodiments of the present disclosure. In an exemplary embodiment, the LCD is positioned in an LCD frame holder. In an exemplary embodiment, the LCD frame holder has moved vertically upward. FIG. 34 shows a vertical movement of an LCD, consistent with one or more exemplary embodiments of the present disclosure. In an exemplary embodiment, the LCD is positioned in an LCD frame holder. In an exemplary embodiment, the LCD frame holder has moved vertically upward. FIG. 35 shows an open position of the headset, consistent with one or more exemplary embodiments of the present disclosure. FIG. 36 shows a closed position of the headset, consistent with one or more exemplary embodiments of the present disclosure.

The disclosed virtual reality headset system represents a paradigm shift in wearable computing architecture, moving beyond the conventional model of sensory replacement to one of adaptive sensory integration. Its fundamental novelty lies in the harmonization of three core technological pillars: dynamic mechanical articulation, cognitive ergonomic design, and versatile operational modality.

The invention's primary mechanical innovation is the synchronized, motor-driven, counterbalancing articulation of the display assembly and the rear visor. This system resolves the persistent ergonomic challenges of weight distribution and inertial instability in head-mounted devices. By actively counteracting the forward torque of the deployed display, the system achieves a state of dynamic equilibrium on the user's head. This not only enhances comfort during prolonged use by preventing pressure points and strain but also enables the use of larger, higher-resolution display modules without compromising wearability. The integrated motorized headband, governed by gyroscopic and accelerometric feedback, provides active stabilization, transforming the device from a passively worn object into an actively conforming platform that maintains its optimal position during user movement.

From a human-computer interaction perspective, the invention introduces a bi-modal operational philosophy that respects natural cognitive processing. In its wearable “standby” mode, the user's primary senses remain unoccluded, maintaining situational awareness and environmental connectivity (a critical factor for professional and industrial applications where safety and peripheral awareness are paramount). The transition to an immersive state is intentional and user-controlled, triggered by a deliberate command. This design aligns with the brain's framework for information valuation, preventing the “artificial dream” effect associated with passive media consumption and promoting deeper engagement and retention of presented information when the immersive mode is actively selected. The convertible audio system, with its sliding speaker pods and integrated earbud charging, further supports this philosophy by allowing seamless transition between private immersion and ambient auditory awareness.

The tabletop mode extends the device's utility beyond personal wearability, reimagining it as an intelligent, interactive display terminal. Utilizing its suite of sensors for user tracking, the device can autonomously orient its display towards the user, functioning as a smart monitor, telepresence endpoint, or collaborative design interface. This dual-purpose functionality consolidates multiple devices (a VR headset and an interactive display) into a single, cohesive platform, offering unprecedented flexibility in both personal and professional computing environments.

Potential applications are vast and cross-disciplinary. In enterprise and industry, the system is ideal for remote assistance, where a field technician can access schematics hands-free while maintaining awareness, or for complex assembly guidance. In design and engineering, it enables immersive 3D modeling and simulation review sessions that can seamlessly transition to a tabletop presentation for collaborative discussion. In medical training and simulation, it offers a hygienic, high-fidelity training tool that can be used in both immersive practice and demonstrative teaching contexts. Furthermore, its ergonomic and cognitively-compatible design makes it suitable for extended use in professional settings, from architecture and education to telecommuting and virtual collaboration, reducing user fatigue and increasing adoption potential.

In summary, this invention provides a unified hardware platform that addresses the long-standing tripartite challenge of ergonomic sustainability, cognitive compatibility, and functional versatility in immersive computing. It is not merely an incremental improvement to existing headset designs but a foundational re-architecture that bridges the gap between human sensory physiology and advanced digital interface technology, paving the way for a new generation of adaptable, human-centric wearable systems.

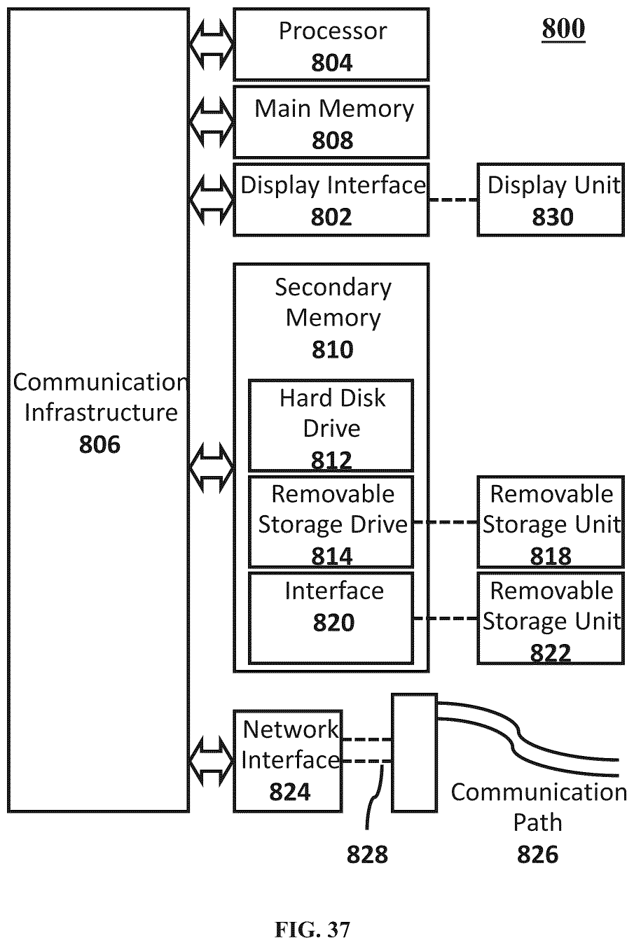

FIG. 37 shows an example computer system 800 in which an embodiment of the present disclosure, or portions thereof, may be implemented as computer-readable code, consistent with one or more exemplary embodiments of the present disclosure. For example, some operations of virtual reality headset 100 may be implemented by utilizing computer system 800 using hardware, software, firmware, tangible computer readable media having instructions stored thereon, or a combination thereof and may be implemented in one or more computer systems or other processing systems. Hardware, software, or any combination of such may embody any of the modules and components of virtual reality headset 100.

If programmable logic is used, such logic may execute on a commercially available processing platform or a special purpose device. One ordinary skill in the art may appreciate that an embodiment of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

An embodiment of the present disclosure is described in terms of this example computer system 800. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general-purpose processor device. As will be appreciated by persons skilled in the relevant art, processor device 804 may also be a single processor in a multi-core/multiprocessor system, such system operating alone, or in a cluster of computing devices operating in a cluster or server farm. Processor device 804 may be connected to a communication infrastructure 806, for example, a bus, message queue, network, or multi-core message-passing scheme.

In an exemplary embodiment, computer system 800 may include a display interface 802, for example a video connector, to transfer data to a display unit 830, for example, a monitor. Computer system 800 may also include a main memory 808, for example, random access memory (RAM), and may also include a secondary memory 810. Secondary memory 810 may include, for example, a hard disk drive 812, and a removable storage drive 814. Removable storage drive 814 may include a floppy disk drive, a magnetic tape drive, an optical disk drive, a flash memory, or the like. Removable storage drive 814 may read from and/or write to a removable storage unit 818 in a well-known manner. Removable storage unit 818 may include a floppy disk, a magnetic tape, an optical disk, etc., which may be read by and written to by removable storage drive 814. As will be appreciated by persons skilled in the relevant art, removable storage unit 818 may include a computer usable storage medium having stored therein computer software and/or data.

In alternative implementations, secondary memory 810 may include other similar means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from removable storage unit 822 to computer system 800.

Computer system 800 may also include a communications interface 824. Communications interface 824 allows software and data to be transferred between computer system 800 and external devices. Communications interface 824 may include a modem, a network interface (such as an Ethernet card), a communications port, a PCMCIA slot and card, or the like. Software and data transferred via communications interface 824 may be in the form of signals, which may be electronic, electromagnetic, optical, or other signals capable of being received by communications interface 824. These signals may be provided to communications interface 824 via a communications path 826. Communications path 826 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 818, removable storage unit 822, and a hard disk installed in hard disk drive 812. Computer program medium and computer usable medium may also refer to memories, such as main memory 808 and secondary memory 810, which may be memory semiconductors (e.g. DRAMs, etc.).

Computer programs (also called computer control logic) are stored in main memory 808 and/or secondary memory 810. Computer programs may also be received via communications interface 824. Such computer programs, when executed, enable computer system 800 to implement different embodiments of the present disclosure as discussed herein. In particular, the computer programs, when executed, enable processor device 804 to implement the processes of the present disclosure. Accordingly, such computer programs represent controllers of computer system 800. Where some operations may be implemented using software, the software may be stored in a computer program product and loaded into computer system 800 using removable storage drive 814, interface 820, and hard disk drive 812, or communications interface 824.

Embodiments of the present disclosure also may be directed to computer program products including software stored on any computer useable medium. Such software, when executed in one or more data processing device, causes a data processing device to operate as described herein. An embodiment of the present disclosure may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

While the foregoing has described what may be considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective spaces of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A virtual reality headset, the virtual reality headset comprising:
a curved rectangular cuboid box, the curved rectangular cuboid box configured to sit on a user's head, the curved rectangular cuboid box comprising:
a front wall;
a back wall;
an upper wall;
a first side handle; and
a second side handle;
an electronic frame with a touch display, the electronic frame movably coupled to the curved rectangular cuboid box, wherein the entire surface of the electronic frame is touch-sensitive and functions as the touch display;
a protective visor, the protective visor movably coupled to the curved rectangular cuboid box, the protective visor comprising a sponge cover configured to rest smoothly against the back of the user's head;
a first motor, the first motor operatively connected to the electronic frame and the protective visor;
a second motor, the second motor operatively connected to the electronic frame and the protective visor;
a first movable speaker box, the first movable speaker box slidably attached to the first side handle, the first movable speaker box configured to:
house a first speaker;
slide upward and downward along the first side handle; and
house a first earphone, the first movable speaker box comprising a first hinged door for inserting and removing the first earphone;
a second movable speaker box, the second movable speaker box slidably attached to the second side handle, the second movable speaker box configured to:
house a second speaker;
slide upward and downward along the second side handle; and
house a second earphone, the second movable speaker box comprising a second hinged door for inserting and removing the second earphone;
a gyroscope sensor and an accelerometer sensor, the gyroscope sensor and the accelerometer sensor configured to detect movement of the user's head;
a rectangular cube module, the rectangular cube module removably attached to the upper wall via spring clamps, the rectangular cube module housing at least one of a Bluetooth communication module, a blood pressure sensor, an additional display screen, control keys, and a supplemental battery;
a plurality of sensors and camera lenses, the plurality of sensors and camera lenses disposed on at least the front wall, the back wall, and a back surface of the electronic frame to provide a 360-degree panoramic sensing capability for virtual and augmented reality;
an electronic pen, the electronic pen configured to be stored in a dedicated box on a lower part of the electronic frame and to provide touch input on the touch display;
a plurality of soft paddings, the plurality of soft paddings disposed on inner walls of the curved rectangular cuboid box and the protective visor, the plurality of soft paddings configured to provide comfort and ventilation to the user's scalp;
a cooling system, the cooling system comprising:
a plurality of air ducts in the back wall; and
an electronic fan, the electronic fan configured to cool electronic components within the curved rectangular cuboid box;
a portable protective case, the portable protective case comprising:
a body;
a lid;
a handle;
a strap;
a first removable drive layer; and
a second removable drive layer; wherein:
the first motor and the second motor are operatively connected to the gyroscope sensor and the accelerometer sensor to adjust an angle of the first side handle and the second side handle via a first hinge and a second hinge to prevent the virtual reality headset from falling off the user's head;
the first motor and the second motor are configured to:
move the electronic frame in a circular axial motion from a first stowed position on the upper wall of the curved rectangular cuboid box to a second deployed position in front of the user's face; and
simultaneously move the protective visor in an opposite circular axial motion from the first stowed position to a third position behind the user's head, thereby providing counterbalancing stability;
the virtual reality headset is configured to operate in a tabletop mode when placed on a surface, and wherein in the tabletop mode, the first motor and the second motor are configured to move the electronic frame based on input from at least one of an eye-tracking sensor, a touch command on the frame, a manual force, a command from the electronic pen, or a voice command, thereby orienting the touch display toward the user;
the first side handle is pivotable via the first hinge to fold inwardly toward a bottom of the curved rectangular cuboid box, and the second handle is pivotable via the second hinge to fold inwardly toward the bottom of the curved rectangular cuboid box, and wherein the electronic frame and the protective visor are configured to fold concurrently with the first side handle and the second side handle;
the first side handle, the second side handle, the electronic frame, and the protective visor each utilize a separate spring coil for their folding movement;
wherein the first movable speaker box comprises a first set of electronic connectors configured to charge the first earphone when stored therein, and the second movable speaker box comprises a second set of electronic connectors configured to charge the second earphone when stored therein;
the electronic frame further comprises a pair of virtual reality glasses mounted on the back surface thereof, the pair of virtual reality glasses being adjustable along a rail to align with the user's eyes;
the first removable drive layer and the second removable drive layer are configured to store and transport the virtual reality headset and additional components including the first movable speaker box, the second movable speaker box, and a keyboard;
the portable protective case comprises an internal battery configured to charge the virtual reality headset, the first movable speaker box, and the second movable speaker box;
external walls of the first movable speaker box and the second movable speaker box comprise a secondary touch and display screen configured to control operations of the virtual reality headset; and
a plurality of sensors and camera lenses are disposed on the back surface of the electronic frame above the pair of virtual reality glasses and on a top side of the touch display, and a pair of speakers and a microphone are disposed on a lower side of the electronic frame.

2. A virtual reality headset, the virtual reality headset comprising:
a curved rectangular cuboid box, the curved rectangular cuboid box configured to sit on a user's head, the curved rectangular cuboid box comprising:
a front wall;
a back wall;
an upper wall;
a first side handle; and
a second side handle;
an electronic frame with a touch display, the electronic frame movably coupled to the curved rectangular cuboid box;
a protective visor, the protective visor movably coupled to the curved rectangular cuboid box;
a first motor, the first motor operatively connected to the electronic frame and the protective visor;
a second motor, the second motor operatively connected to the electronic frame and the protective visor;
a first movable speaker box, the first movable speaker box slidably attached to the first side handle, the first movable speaker box configured to:
house a first speaker; and
slide upward and downward along the first side handle;
a second movable speaker box, the second movable speaker box slidably attached to the second side handle, the second movable speaker box configured to:
house a second speaker; and
slide upward and downward along the second side handle;
wherein the first motor and the second motor are configured to:
move the electronic frame in a circular axial motion from a first stowed position on the upper wall of the curved rectangular cuboid box to a second deployed position in front of the user's face; and
simultaneously move the protective visor in an opposite circular axial motion from the first stowed position to a third position behind the user's head, thereby providing counterbalancing stability.

3. The virtual reality headset of claim 2, further comprising a gyroscope sensor and an accelerometer sensor, the gyroscope sensor and the accelerometer sensor configured to detect movement of the user's head, wherein the first motor and the second motor are operatively connected to the gyroscope sensor and the accelerometer sensor to adjust an angle of the first side handle and the second side handle via a first hinge and a second hinge to prevent the virtual reality headset from falling off the user's head.

4. The virtual reality headset of claim 3, further comprising:
a first earphone, the first earphone configured to be housed within the first movable speaker box, the first movable speaker box comprising a first hinged door for inserting and removing the first earphone; and
a second earphone, the second earphone configured to be housed within the second movable speaker box, the second movable speaker box comprising a second hinged door for inserting and removing the second earphone.

5. The virtual reality headset of claim 4, wherein:
the first movable speaker box comprises a firs set of electronic connectors, the first set of electronic connectors configured to charge the first earphone when stored therein; and
the second movable speaker box comprises second set of electronic connectors, the second set of electronic connectors configured to charge the second earphone when stored therein.

6. The virtual reality headset of claim 5, wherein the electronic frame further comprises a pair of virtual reality glasses, the pair of virtual reality glasses mounted on a back surface of the electronic frame, the pair of virtual reality glasses being adjustable along a rail to align with the user's eyes.

7. The virtual reality headset of claim 6, wherein the curved rectangular cuboid box further comprises a rectangular cube module, the rectangular cube module removably attached to the upper wall via spring clamps, the rectangular cube module housing at least one of a Bluetooth communication module, a blood pressure sensor, an additional display screen, control keys, and a supplemental battery.

8. The virtual reality headset of claim 7, further comprising a plurality of sensors and camera lenses, the plurality of sensors and camera lenses disposed on at least the front wall, the back wall, and the electronic frame to provide a 360-degree panoramic sensing capability for virtual and augmented reality.

9. The virtual reality headset of claim 8, further comprising an electronic pen, the electronic pen configured to be stored in a dedicated box on a lower part of the electronic frame and to provide touch input on the touch display.

10. The virtual reality headset of claim 9, wherein:
the first side handle is pivotable via a first hinge to fold inwardly toward a bottom of the curved rectangular cuboid box;
the second handle is pivotable via a second hinge to fold inwardly toward the bottom of the curved rectangular cuboid box; and
the electronic frame and the protective visor are configured to fold concurrently with the first side handle and the second side handle.

11. The virtual reality headset of claim 10, wherein the first side handle, the second side handle, the electronic frame, and the protective visor each utilize a separate spring coil for their folding movement.

12. The virtual reality headset of claim 11, further comprising a plurality of soft paddings, the plurality of soft paddings disposed on inner walls of the curved rectangular cuboid box and the protective visor, the plurality of soft paddings configured to provide comfort and ventilation to the user's scalp.

13. The virtual reality headset of claim 12, further comprising a cooling system, the cooling system comprising:
a plurality of air ducts in the back wall; and
an electronic fan, the electronic fan configured to cool electronic components within the curved rectangular in the cuboid box.

14. The virtual reality headset of claim 13, configured to operate in a tabletop mode, wherein:
the virtual reality headset is placed on a surface;
the first motor and the second motor are configured to move the electronic frame based on input from at least one of an eye-tracking sensor, a touch command on the frame, a manual force, a command from the electronic pen, or a voice command, thereby orienting the touch display toward the user.

15. The virtual reality headset of claim 14, wherein the protective visor comprises a sponge cover, the sponge cover configured to rest smoothly against the back of the user's head.

16. The virtual reality headset of claim 15, further comprising a portable protective case, the portable protective case comprising:
a body;
a lid;
a handle;
a strap;
a first removable drive layer, the first removable drive layer configured to store and transport the headset and additional components including the first moveable speaker box, the second movable speaker box, and a keyboard; and
a second removable drive layer, the second removable drive layer configured to store and transport the headset and additional components including the first moveable speaker box, the second movable speaker box, and the keyboard.

17. The virtual reality headset of claim 16, wherein the portable protective case comprises an internal battery, the internal battery configured to charge the virtual reality headset, the first movable speaker box, and the second movable speaker box.

18. The virtual reality headset of claim 17, wherein external walls of the first movable speaker box and the second movable speaker box comprise a secondary touch and display screen, the secondary touch and display screen configured to control operations of the headset.

19. The virtual reality headset of claim 18, wherein the entire surface of the electronic frame is touch-sensitive and functions as the touch display.

20. The virtual reality headset of claim 19, further comprising:
a plurality of sensors and camera lenses, the plurality of sensors and camera lenses disposed on a back surface of the electronic frame above the pair of virtual reality glasses; and on a top side of the touch display;
a pair of speakers, the pair of speakers disposed on a lower side of the electronic frame; and
a microphone, the microphone disposed on a lower side of the electronic frame.
